(19) United States
(12) Patent Application Publication
(10) Pub. No.: US 2016/0162442 A1
(43) Pub. Date: Jun. 9, 2016

(54) CLOUD BASED SYSTEMS AND METHODS FOR STORING, ORGANIZING AND MANAGING PORTABLE DIGITAL FORMAT DOCUMENTS

(71) Applicant: Justin Esgar, New York, NY (US)

(72) Inventor: Justin Esgar, New York, NY (US)

(21) Appl. No.: 14/558,999

(22) Filed: Dec. 3, 2014

(51) Int. Cl. G06F 17/21; H04L 29/08; G06F 17/30

(52) U.S. Cl. CPC G06F 17/212; G06F 17/30011; H04L 67/10

(57) ABSTRACT

A cloud based computer implemented system for managing a plurality of portable digital format documents, comprising; memory that stores computer-executable instructions; a processor, communicatively coupled to the memory that facilitates execution of the computer-executable instructions to at least: transmit a portable digital format document, from a sender, to be digitally signed by a user; open a portable digital format document stored in the system of the user or the sender; wherein the user digitally signs the portable digital format document and the portable digital format document is stored in the cloud based environment of the user and the sender; manage the storage of the signed portable digital format document; determine whether the portable digital format document has been digitally signed and alerting the user and the sender if it has not; and record the metadata associated with the portable digital format document.

### FIELD OF THE EMBODIMENTS

This invention relates to a cloud based system for managing a plurality of portable digital format documents.

### BACKGROUND OF THE EMBODIMENTS

Examples of related art are described below:

International PCT Publication No. WO 2013105941 discloses a trusted cloud service such as an “electronic vault” which store records of a consumer's electronic data file history and which acts as online notary system. US Patent Publication No. 2014/0040611 discloses methods for distributed validation of a digitally signed electronic document. U.S. Patent Publication No. 2010/0100743 teaches an application program which can generate an electronic document for receiving a signature graphic; calculate a hash value from the electronic document and the signature graphic, and create a cryptographic signature from the hash value using a cryptographic encryption method. U.S. Pat. No. 8,205,087 teaches a software tool for digitally signing multiple documents. U.S. Pat. No. 8,385,981 teaches a system to store digital renderings of wet signatures using a conventional mobile communication device having a camera feature. U.S. Pat. No. 8,745,748 discloses a system and method for enabling a client to request a server to cancel the digital signing of a form file. None of the art described above addresses all of the issues that the present invention does.

### SUMMARY OF THE EMBODIMENTS

A cloud based computer implemented system for managing a plurality of portable digital format documents, comprising; memory that stores computer-executable instructions; a processor, communicatively coupled to the memory that facilitates execution of the computer-executable instructions to at least: transmit a portable digital format document, from a sender, to be digitally signed by a user; open a portable digital format document stored in the system of the user and the sender; wherein the user digitally signs the portable digital format document and the portable digital format document is stored in the cloud based environment of the user and the sender; manage the storage of the signed portable digital format document; determine whether the portable digital format document has been digitally signed and alerting the user and the sender if it has not; and record the metadata associated with the portable digital format document.

A cloud based computer implemented method for managing a plurality of portable digital format documents, the steps being executed via a processor comprising: transmitting a portable digital format document, from a sender, to be digitally signed by a user; opening a portable digital format document stored in the system of the user; digitally signing the portable digital format document; storing the portable digital format document in the cloud based environment of the user or the sender; managing the storage of the signed portable digital format document; determining whether the portable digital format document has been digital signed and alerting the user and the sender if it has not; and recording the metadata associated with the portable digital format document.

It is an object of the present invention wherein the plurality of elements is added to the portable digital format document.

It is an object of the present invention wherein the metadata comprise at least one of date, time and location of the portable digital format document when digitally signed.

It is an object of the present invention wherein the portable digital format document is digitally signed by a plurality of users.

It is an object of the present invention wherein the digital signature is located in multiple locations on the portable digital format document.

It is an object of the present invention wherein a plurality of portable digital format documents can be managed.

It is an object of the present invention wherein the portable digital format document to be accessed is uploaded or downloaded from at least one of a cloud based system, a mobile or hand held device, and a third party document management program of the user and the sender.

It is an object of the present invention wherein the plurality of elements include at least one of text, signature, saved signature, checkmark, radio button, and date.

It is an object of the present invention wherein a digital image or photo is added to the portable digital format document.

It is an object of the present invention wherein metadata of the digital image or digital photo is stored on the cloud based system of the user and the sender.

It is an object of the present invention wherein the portable digital format document can be resized or rotated.

It is an object of the present invention wherein a plurality of signatures are stored for future insertion into the portable digital format document.

It is an object of the present invention wherein the time and date of the portable digital format document is recorded for authentication purposes.

It is an object of the present invention wherein the system of the user includes at least one of Google Drive, Box, Dropbox, Dropbox sync from an email, from the app, from SignMyPad Cloud.

### BRIEF DESCRIPTION OF THE DRAWINGS

FIG. 1 shows an illustrative view of the Document List icon screen of the invention.

FIG. 2 shows an illustrative view of the Add Document screen of the invention.

FIG. 3 shows an illustrative view of the Upload feature of the invention.

FIG. 4 shows an illustrative view of the New Folder feature of the invention.

FIG. 5 shows an illustrative view of the Save your Signature feature of the invention.

FIG. 6 shows an illustrative view of the Save your Signature feature of the invention with a saved signature.

FIG. 7 shows an illustrative view of the Save your Signature feature of the invention with a saved signature using the thickness feature.

FIG. 8 shows an illustrative view of the PDF list view screen of the invention showing the Meta data captured.

FIG. 9 shows an illustrative view of the Meta data captured of a PDF of the invention.

FIG. 10 shows an alternative illustrative view of the Meta data captured of a PDF of the invention.

FIG. 11 shows an illustrative view of the PDF List view screen of the invention.

FIG. 12 shows an alternative illustrative view of the PDF List view screen of the invention.

FIG. 13 shows an alternative illustrative view of the Upload screen of the invention.

FIG. 14 shows an alternative illustrative view of the Upload screen of the invention.

FIG. 15 shows an alternative illustrative view of the Upload screen of the invention.

FIG. 16 shows an illustrative view of the Add Folder feature of the invention.

FIG. 17 shows an illustrative view of the Saved Signature screen of the invention.

FIG. 18 shows an illustrative view of the Cloud Services screen of the invention.

FIG. 19 shows an illustrative view of the Manage Documents screen of the invention.

FIG. 20 shows an illustrative view of the Tools Menu feature of the invention.

FIG. 21 shows an illustrative view of the Add Feature Menu screen of the invention.

FIG. 22 shows an illustrative view of the Add Text screen of the invention.

FIG. 23 shows an illustrative view of the Add Signature screen of the invention.

FIG. 24 shows an alternative illustrative view of the Add Feature Menu screen of the invention

FIG. 25 shows an illustrative view of the Save As screen of the invention

FIG. 26 shows an illustrative view of the Preview Saved Document screen of the invention.

FIG. 27 shows an illustrative view of the Upload Options screen of the invention.

FIG. 28 shows an illustrative view of the Upload to Cloud Services screen of the invention.

FIG. 29 shows an illustrative view of the main screen of the cloud based system of the invention.

FIG. 30 shows an illustrative view of the bill of lading screen of the cloud based system of the invention.

FIG. 31 shows an alternative view of the Bill of Lading screen of the cloud based system of the invention.

FIG. 32 shows an illustrative view of the Bill of Lading screen showing an executed signature of the cloud based system of the invention

FIG. 33 shows an illustrative view of the returned PDF screen of the cloud based system of the invention

FIG. 34 shows an illustrative view of the Signed List screen of the cloud based system of the invention

FIG. 35 shows an illustrative view of the Upload File screen of the cloud based system of the invention

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

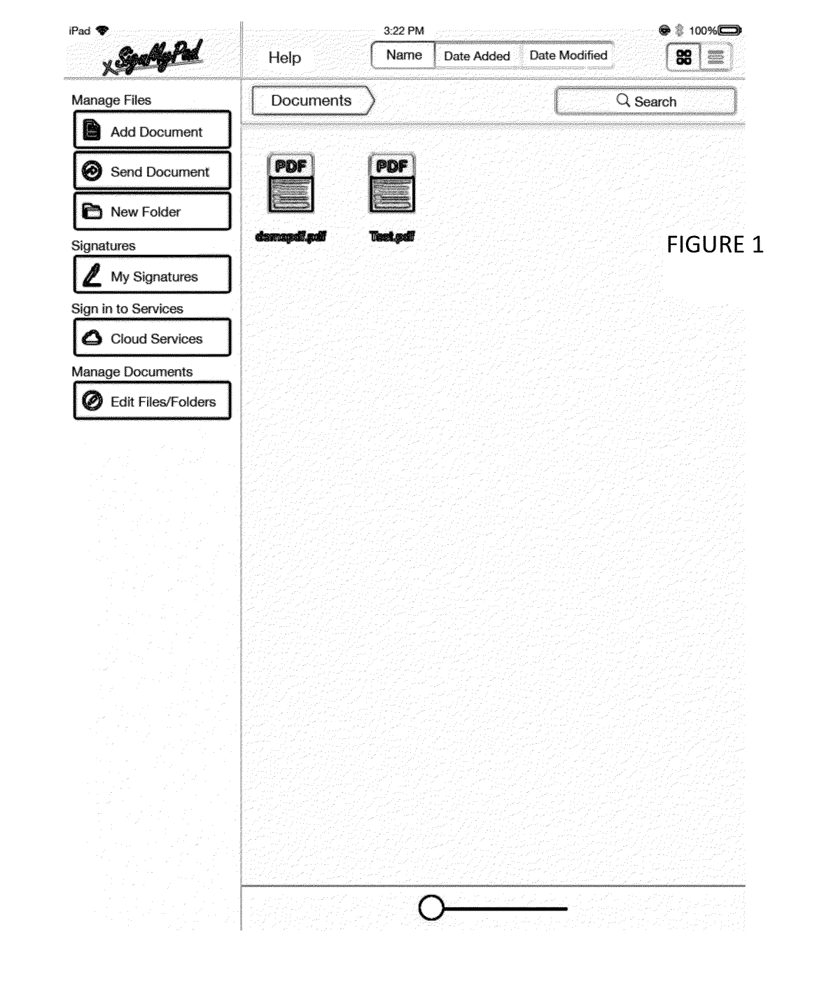

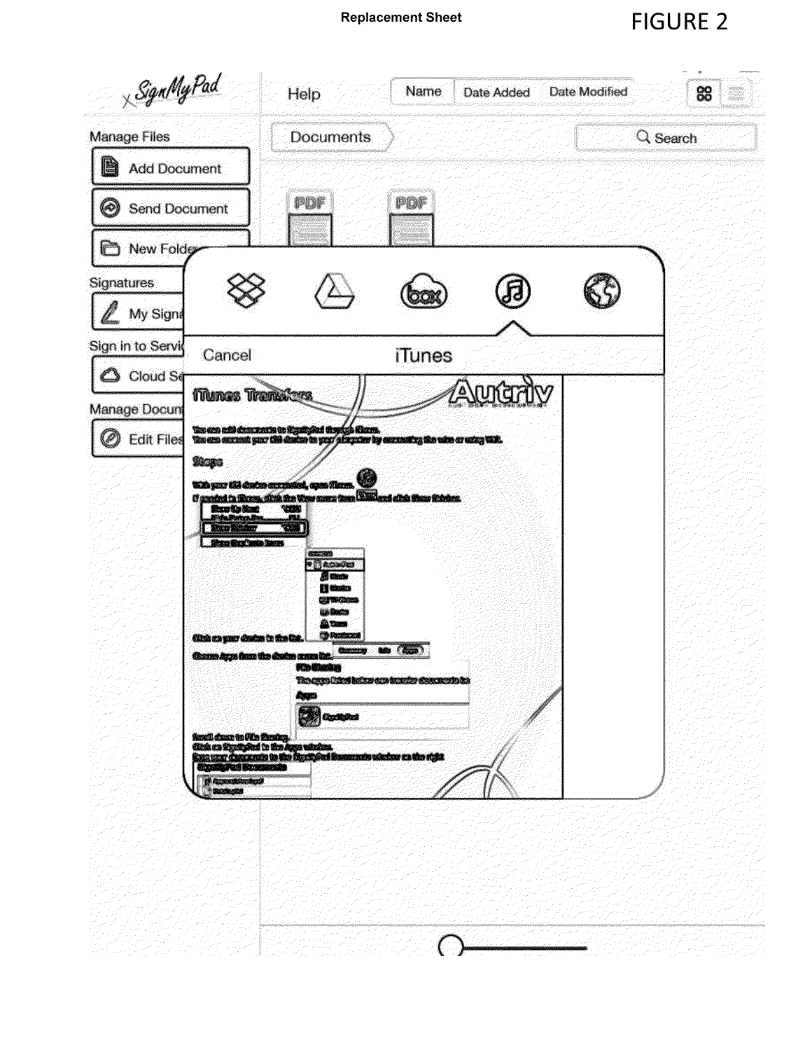

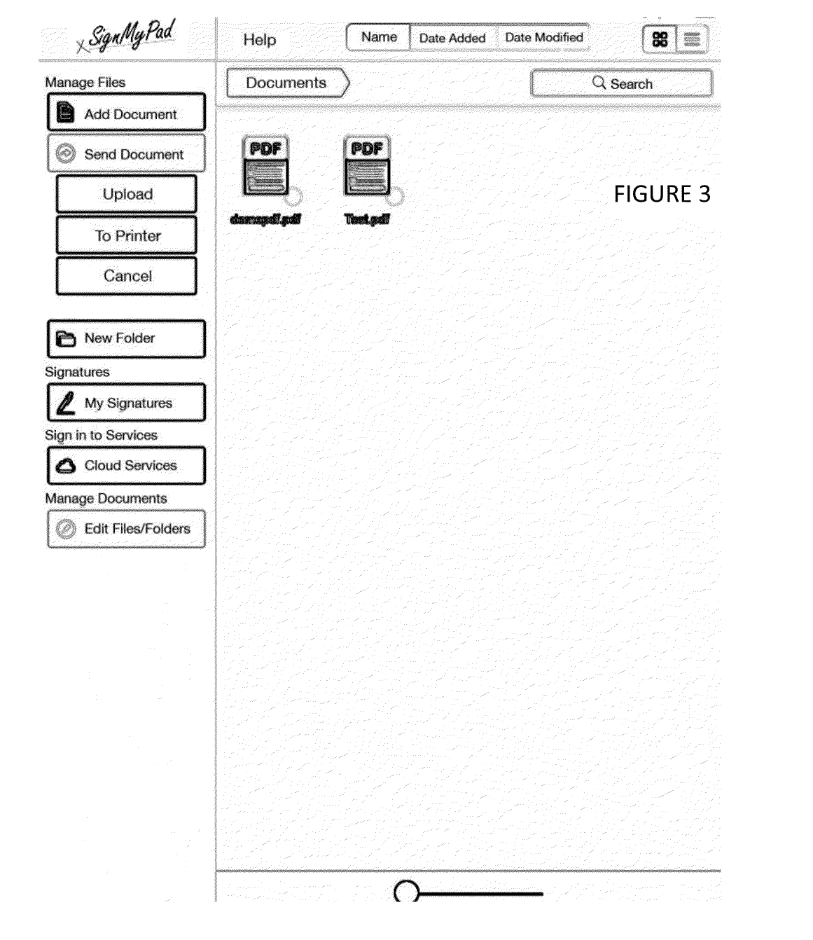

Using the present invention comprises the following steps. Prior to logging to the system a user is asked to verify their identity. Once verified, upon logging in to the present inventions system and/or application, a user is presented with a dashboard on the Home Screen. The dashboard is the view of the application when the application is accessed. A user can view a portable digital format (herein PDF) document list in icon view or list view (as shown in FIG. 1) by selecting icon or list view buttons. FIG. 2 shows an illustrative view of the Add Document screen of the invention where a user may add documents from within the present application or from the application's cloud based service. A user may add a document from Dropbox, Google Drive, Box, via iTunes, or download a document from the web. FIG. 3 shows an illustrative view of the Upload feature of the invention where a user may select the PDF(s) they want to upload and select Upload or To Printer. Upload will allow a user to upload a PDF to Dropbox, Google Drive, Box, or a user's Email.

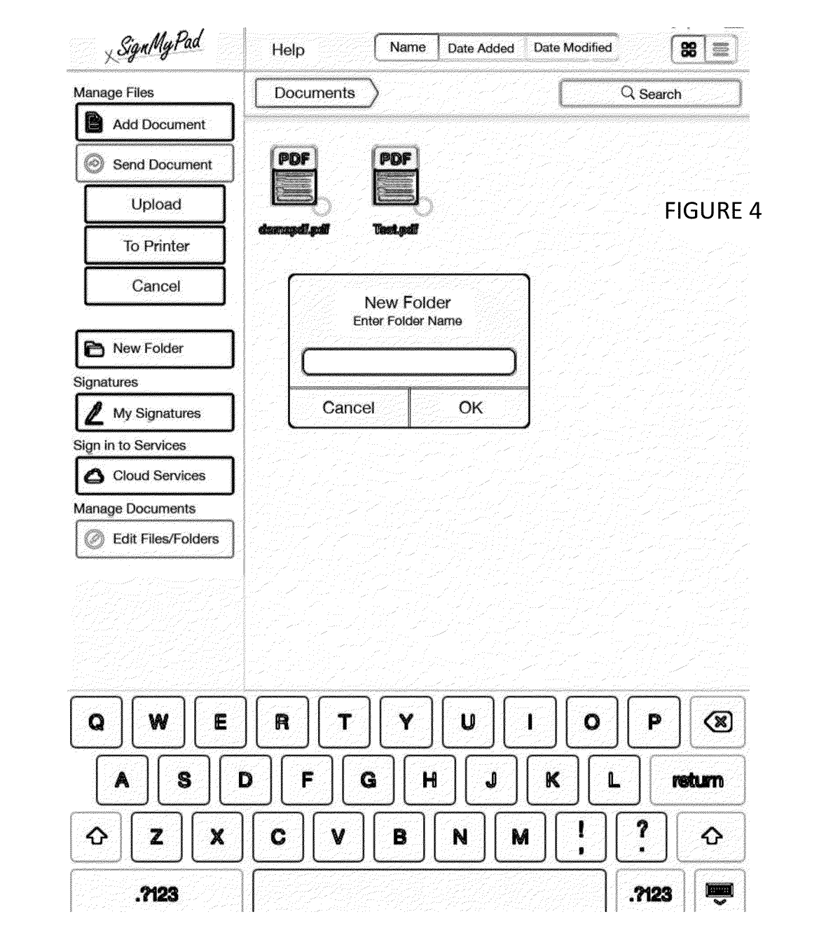

As shown in FIG. 4, to create a new folder, a user may select the New Folder button. A user will be prompted to enter a name for the folder and selecting OK creates the folder. The edit button, as found in the tools menu will allow a user to move, rename, copy and delete files and folders. To move files between folders, a user may select Edit files, choose the PDFs or folders they wish to move, and select Move Files. A user may then navigate the PDF into the folder a user wants the files to be saved or stored in. Selecting done completes the move.

To rename a file, a user may choose the PDF or folder a user wishes to rename and select Rename Files. When prompted, a user may enter a new name for the selected file and then selects “Ok”. A user may only rename one file or folder at a time. In another embodiment, a user may be able to rename multiple files at multiple times.

To copy a file a user may select the Edit files button, choose the PDFs or folders a user wishes to copy and then select the Copy Files button. A user then chooses where the user wishes the copied files to go. Selecting done completes the copy function. If a user uses the copy feature and places the copied document into the same folder as the original, a user will be prompted to either replace the original or keep both. If a user chooses to replace the original, the file will be overwritten. If the user chooses to keep both files, a number will be appended to the end of the file name in sequential order.

To delete a file, a user may select the Edit files button from the tools menu. A user then selects the PDFs or folders they wish to delete and selects the Delete File button. If a user uses the Dropbox Sync option, they cannot edit the special folder created called SMP Shared. To remove the SMP Shared folder a user must turn off Dropbox Sync via the Settings window.

The settings button is used to login or logout of cloud services a user wishes to use. To login or out of cloud services, a user may select the Gear button, then the service a user desires to work with and then select either Login or Logout. A user may Upload and Download a PDF document using cloud services such as Dropbox, Google Drive, Box, and SignMyPad Cloud.

The Path bar as shown in FIG. 1 shows a user which folder they are viewing including the PDF documents found in respective folder. The main document folder may be named /Documents folder. By selecting the home button, a user will be brought back to the /Documents folder. In addition, the Back button will bring a user back one move.

In icon view there is an interactive slider feature which allows a user to make the icons larger or smaller by sliding the slider in one direction. A preview of the first page of a PDF will appear if the slider is moved to the right. In another embodiment, a preview of the last page of the PDF will appear if the slider is moved to the left.

To add elements to a PDF, a user may select a PDF. The menu bar contains the following options/buttons: the PDF menu, Tools Menu, Add Menu, and Save Menu.

The PDF menu button will return a user back to the PDF List.

Under the tools menu is the following options:
Rotate—These buttons will rotate the page or pages a user is currently looking at 90 degrees either clockwise or counterclockwise.
Remove Page—This button will remove the page a user is looking at from the entire document
Detect Forms—This button will detect the Acrobat forms on a PDF. A user may select into the forms that are detected for easier entry

Under the Add button is the following options and elements:
Text button—Use this to add text to a PDF. A user may change the font by scrolling the wheel. In another embodiment, a user may choose other styles and colors of their text appearance and change the text font, size and thickness.
Signature button—Use this to add a signature to the PDF. A user may select the pen color and pen thickness. A user may choose from a thin, medium and thick thickness. In another embodiment, a user may choose other styles and line weights of their signature's appearance.
The Saved Signatures button will recall the list of saved signatures and place that signature right into the document
The checkbox button will add an X to a PDF document
The radio button will add a • to a PDF document.
The Date button will add the date to a PDF. A user may specify the date format to short (04/30/13), medium (Apr. 30, 2013) and long (Apr. 30, 2012). A user may also add a Time Stamp which will attach the time to the date entry
A user may add a photo to their document

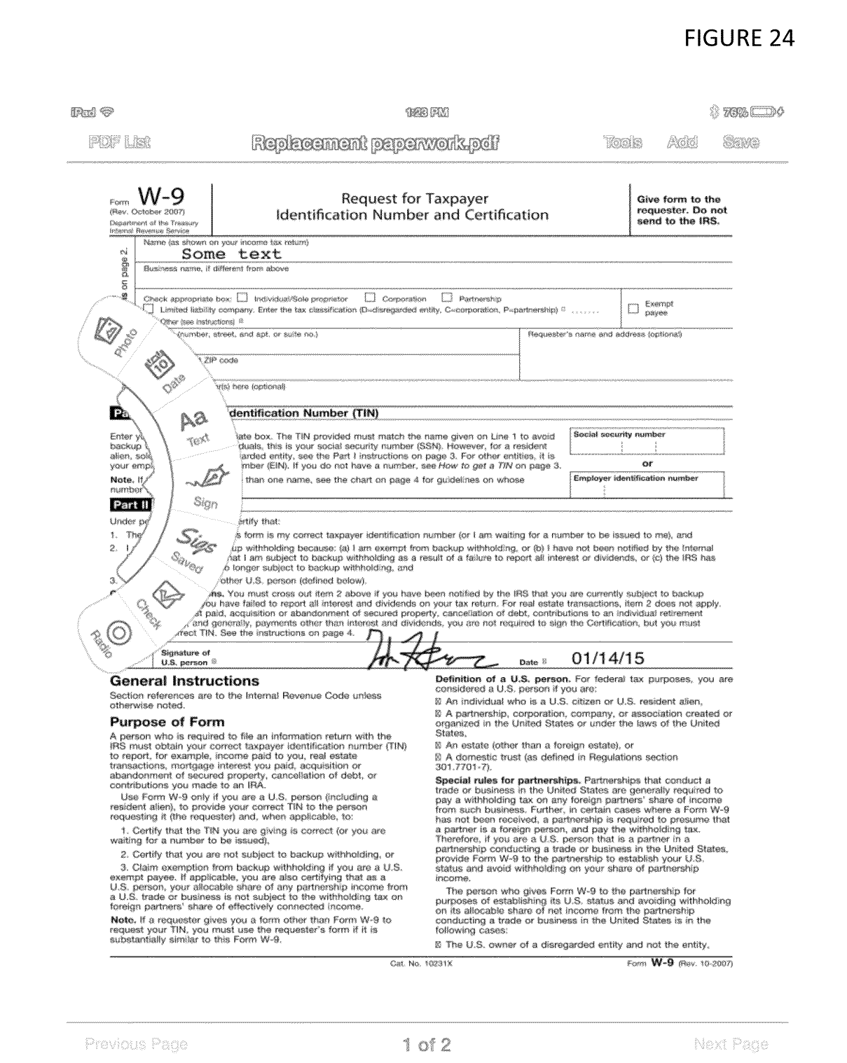

In the event the add menu is too close to the edge of the PDF or document, the arced add menu will appear in a different location as shown in FIG. 24. In another embodiment, the Add Menu features can be displayed in various shapes and sized. To change the size of an element, a user may select the item they wish to change and a slider will appear at the top of the screen. The slider is used to adjust the element to fit a user's needs. To remove any element, the element may be selected by the user. A user will then be prompted to remove the element. The previous page button and the next pages button will move between the pages of the PDF.

Under the Save button is:
Save and Save As— The Save option will save the PDF with the same name in the same location of where it was opened from. Save as option will allow a user to choose the name of the PDF and the location of where a user desires to save it. This allows a user to save multiple copies of a PDF. In another embodiment Save a Copy As option will allow a user to save a copy to another folder outside of the SignMyPad folder structure.

In another embodiment, a portable digital format document or PDF can be accessed by depressing the Open In button as part of the user's application. This feature can also be accessed when a user attempts to open a PDF from a user's email or another application such as a word processing application. When accessing a document from another application, the system's application will allow a user to view documents that are in the PDF format. The user's application will open once a PDF document is selected. If a user is opening a PDF from an email program and the PDF is an attachment in an email message, the Open In option will commence once the user has selected the PDF document to be opened.

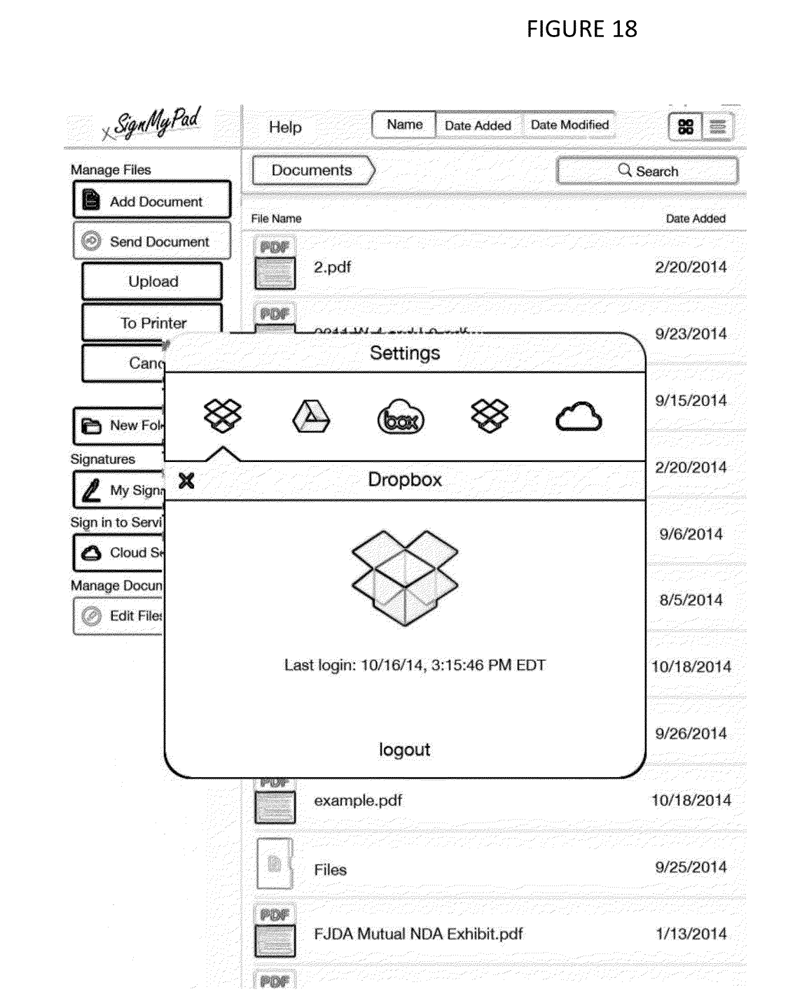

Accessing the application, allows a user to store, upload, email and download multiple PDFs. By selecting the tools menu and selecting the Download button, a user is able to view what PDF's are stored on the application or associated system. The application can also be accessed via the World Wide Web. A use may type in the URL or web address ending in dot PDF to access a particular PDF. A user may also access a PDF from Dropbox or similar file hosting service that offers cloud storage, file synchronization, personal cloud, and client software options. Once in the application, a user can select the Dropbox option and select the PDF or PDFs a user desires and then subsequently selecting the download button to initiate the download. A user may access a PDF or multiple PDF's through Google Drive, or similar file storage and synchronization service which also enables user cloud storage, file sharing and collaborative editing. A user may select the Google Drive option in the application as shown in and select the PDF or PDFs desired and subsequently select the download button to commence the download. A user may also download a PDF or PDF's by using Box or similar perianal file management systems. By selecting the Box option in the application as shown in FIG. 18, a user may then select the PDF or PDF's they desire to open and then select the download button to initiate the download. In the present invention, a user will be required to link their system's account to their cloud based account.

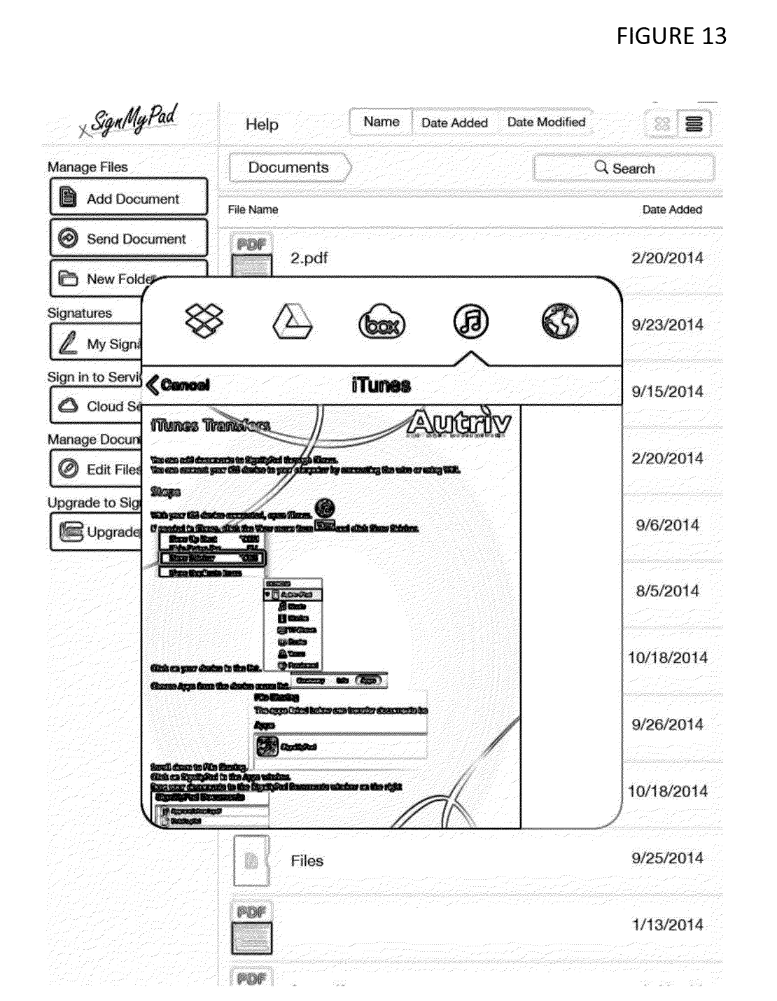

The system in the present invention also enables a user to access PDF's from their computer via the iTunes application as shown in FIG. 13. In addition, a user may wirelessly or wired connect their smart pad or mobile phone to a computer to access PDF or PDF's. From a user's email or mail exchange program, a PDF may be selected which will cause the initiation of the present inventions application. A user will be able to upload multiple PDF's to the present inventions application, by selecting the upload feature. Similarly, a user may desire to email a PDF which can be commenced by uploading a PDF and depressing the Send button. Uploading a PDF in the present application can be achieved by selecting the Upload button. Likewise, PDF's can be uploaded and emailed from Dropbox, Google Drive, Box or similar programs.

The present application allows a user to print a PDF or multiple PDF's by selecting the Print option. Whether the PDF is stored in the application or not, a user may simply upload the document to the application or email a PDF to the application and then print the desired PDF. To print a PDF, select the Upload Files button, select the PDFs to print and select the To Printer button. This only works with AirPrint compatible printers. In another embodiment, the To Printer option will be compatible with all types of printers.

The present application allows a user to send a PDF to another application such as iBook's by selecting the Upload Files feature, selecting the PDF's to send, selecting the Upload option, selecting the Open In option, and choosing the application you wish to send the PDF's to.

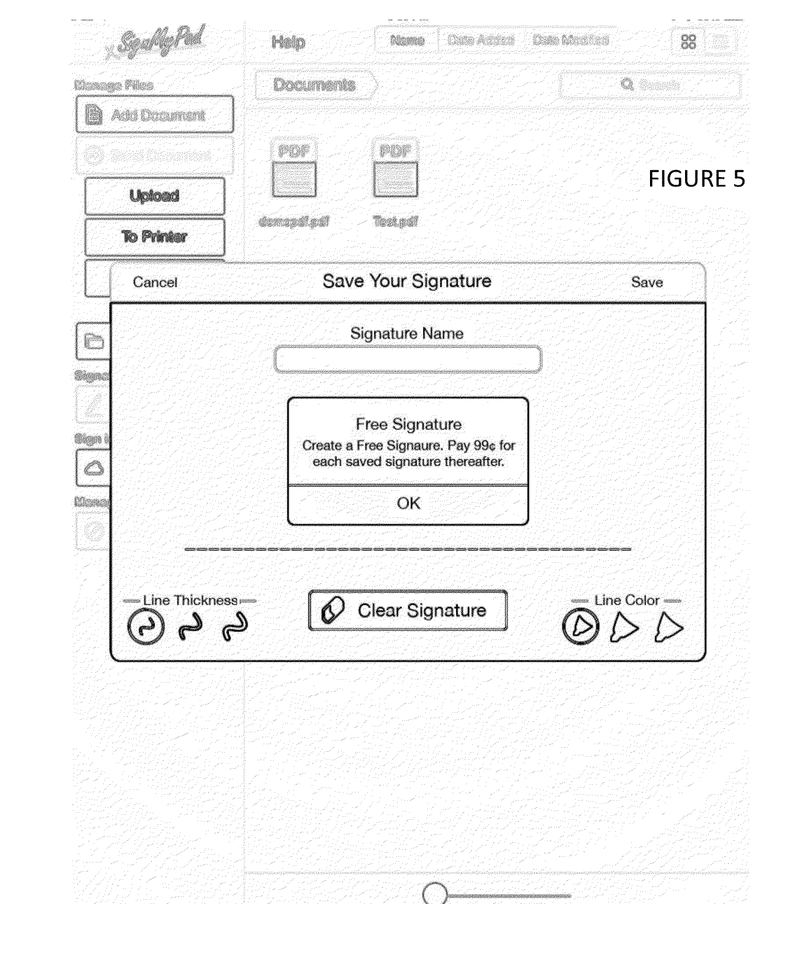

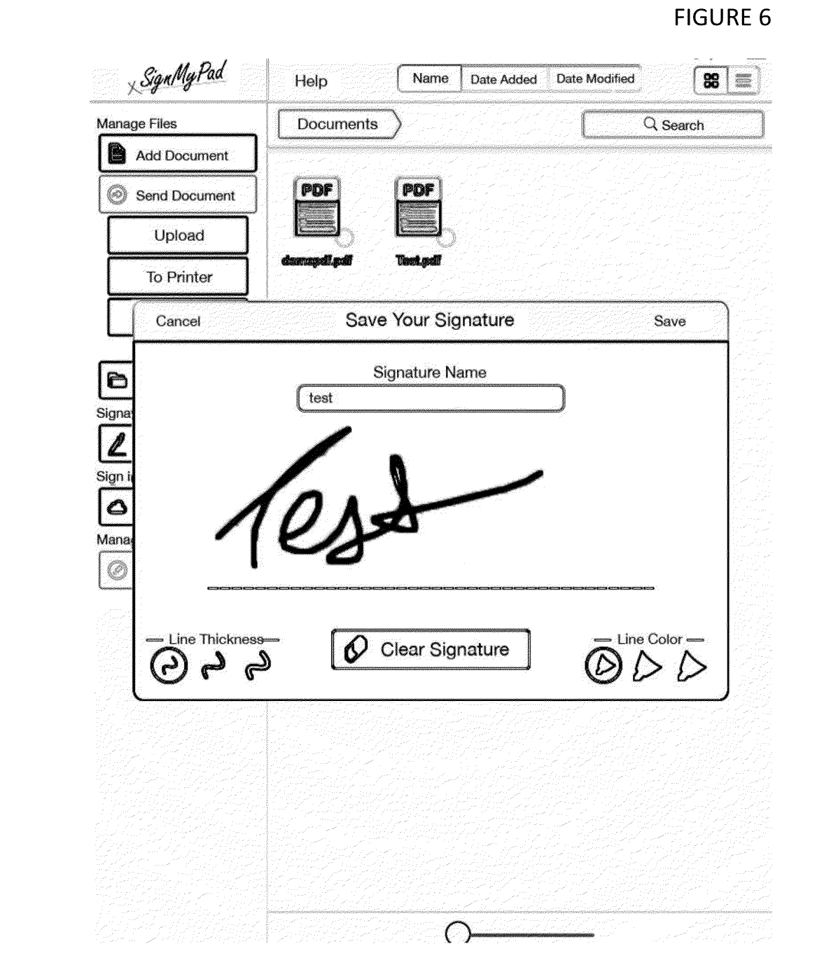

A user wishing to use iCloud or Dropbox Sync to sync documents between the different SignMyPad versions may do so from the Settings menu. A user may save one or more signatures in the present application. The present application allows a user to save up to 20 signatures and/or purchase additional space to save additional signatures. To save a signature, select the Save Your Signature button from the PDF list which may be located on the sidebar. The signature pane will show as shown in FIG. 5. A user may select their pen color from either black, red or blue. In another embodiment, additional colors will be featured. A user may select their pen thickness as shown in FIG. 6. Once a user executes or signs a PDF, selecting save option will save the signature in the application. A user may name their signatures when prompted.

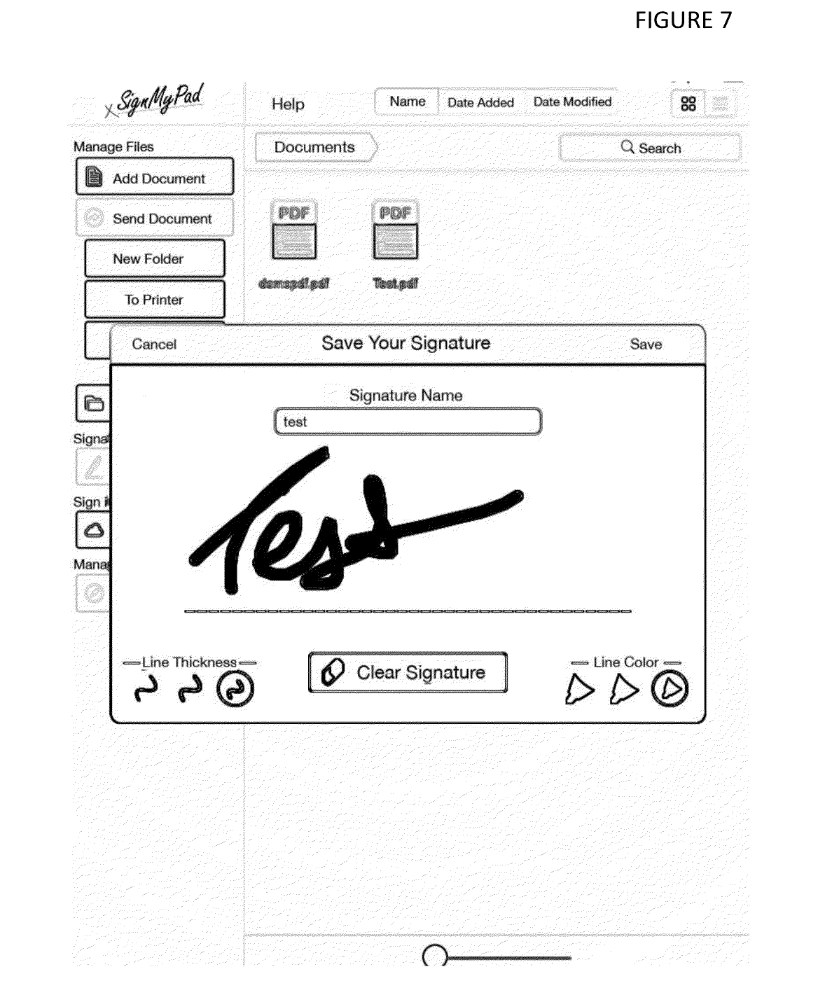

To purchase another space to save a signature, a user may select the Save your Signature button as shown in FIG. 7. If a user has used their free space, a window will show asking if the user wishes to buy additional space. At which point a user can select the Buy a new Signature space button.

If a user removes the present application from their mobile device or computer system, all signatures will be deleted. A user may restore the spaces purchased but a user will have to resave the actual signatures in each space. In another embodiment, a user may not have to resave the actual signatures in each space to restore their saved signature spaces, a user may select the Save Your Signature button from the tools menu and choose the Restore Signature Spaces button/option. The signature spaces will return with the names assigned.

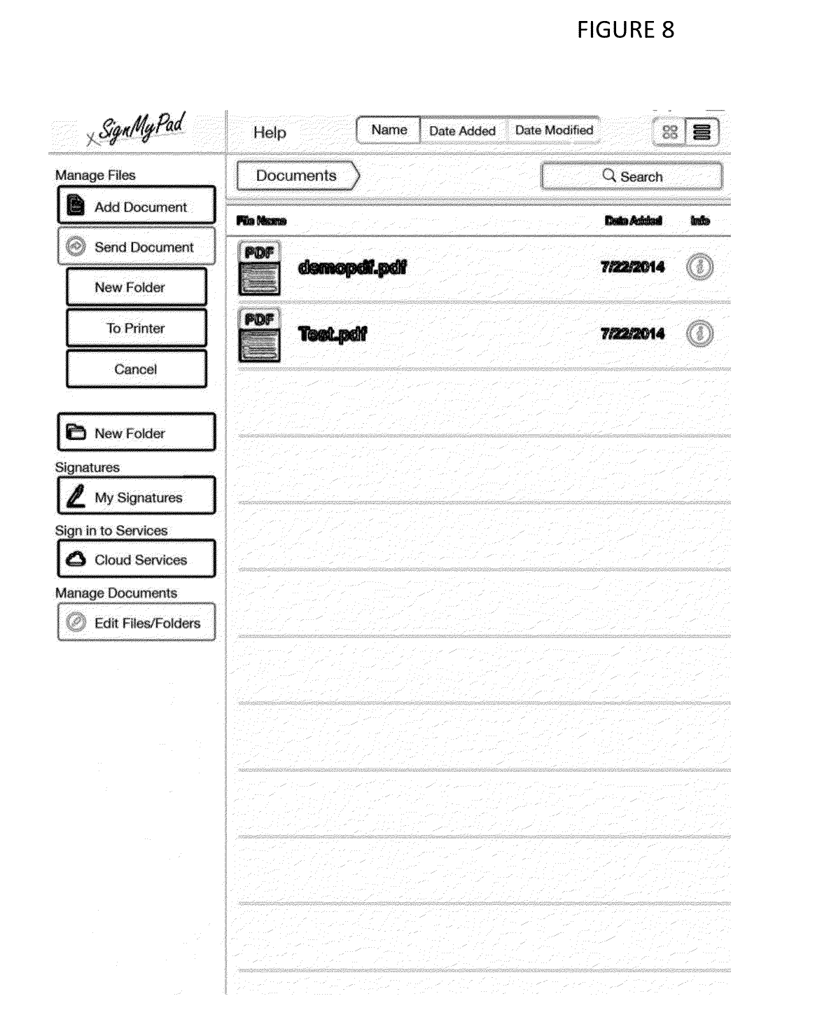

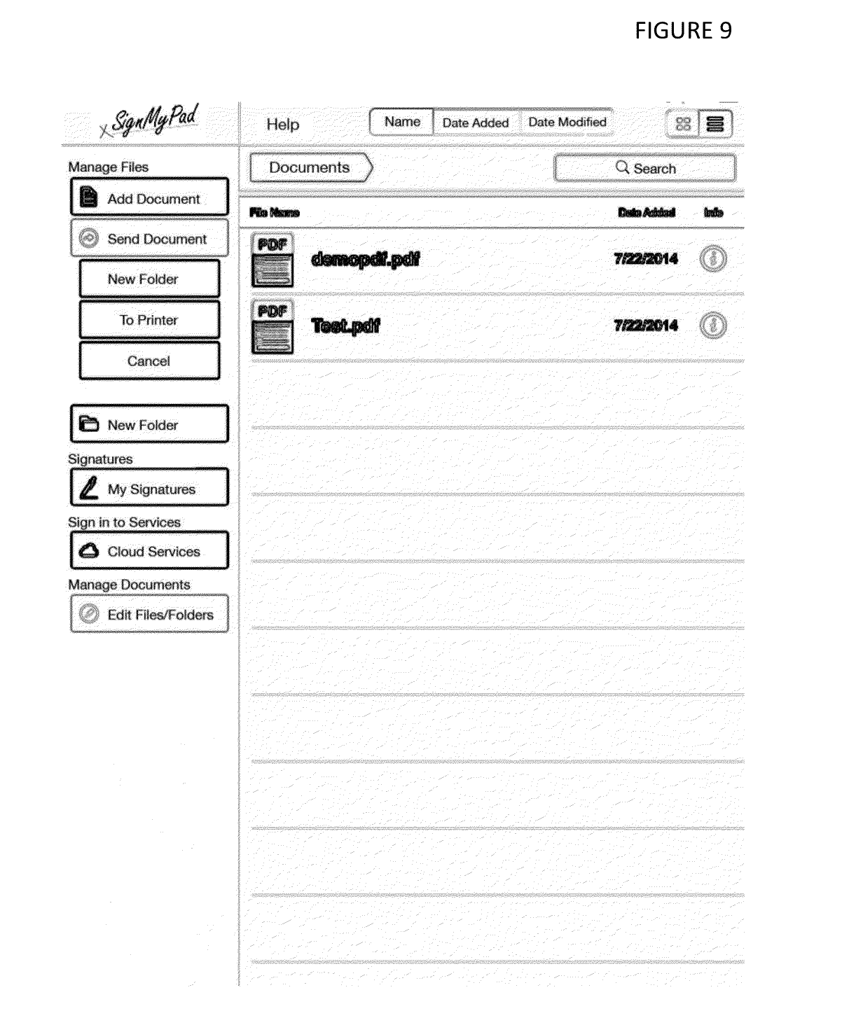

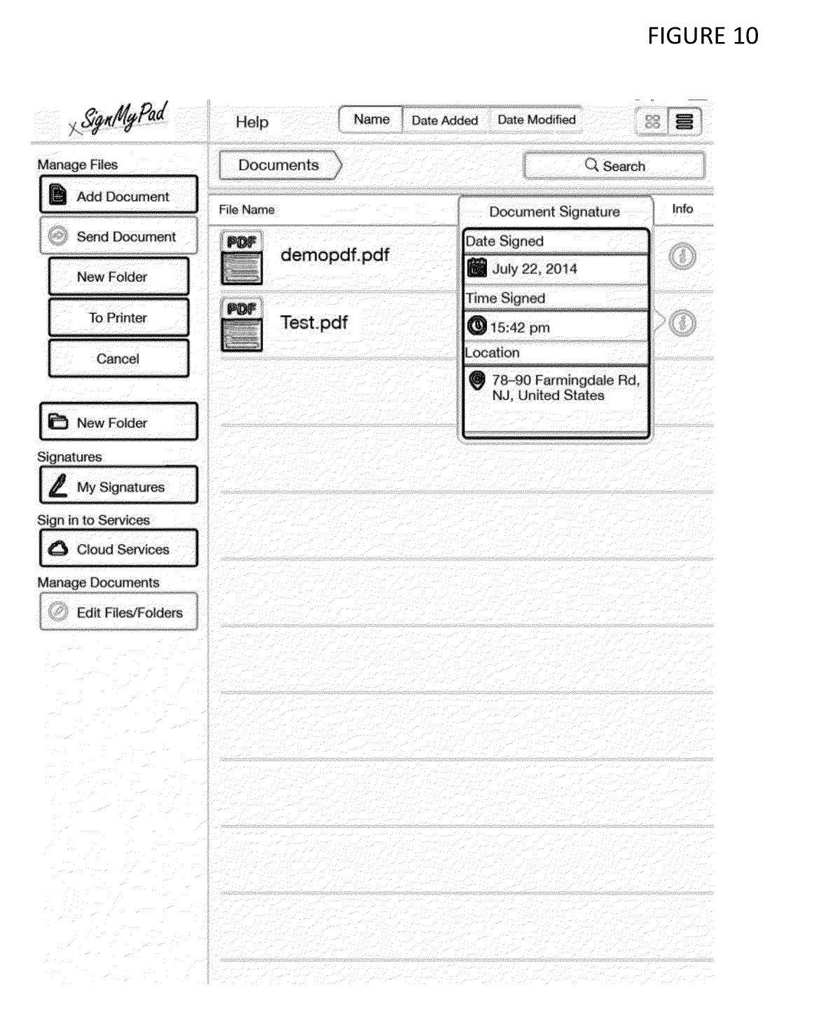

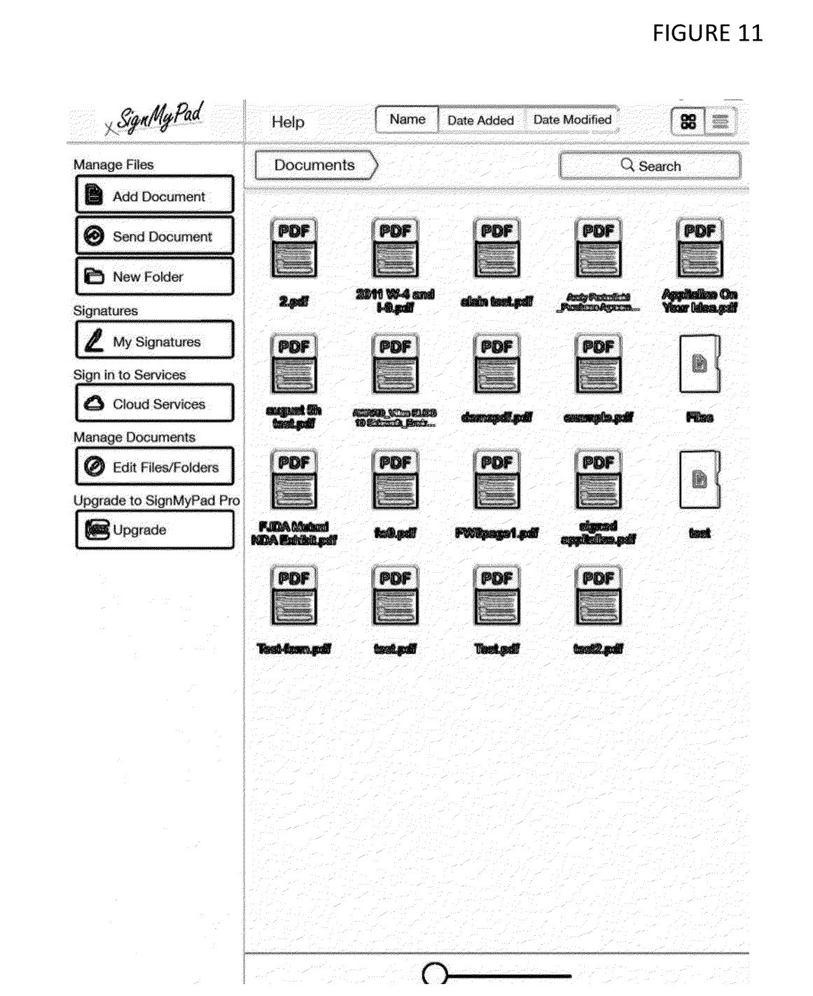

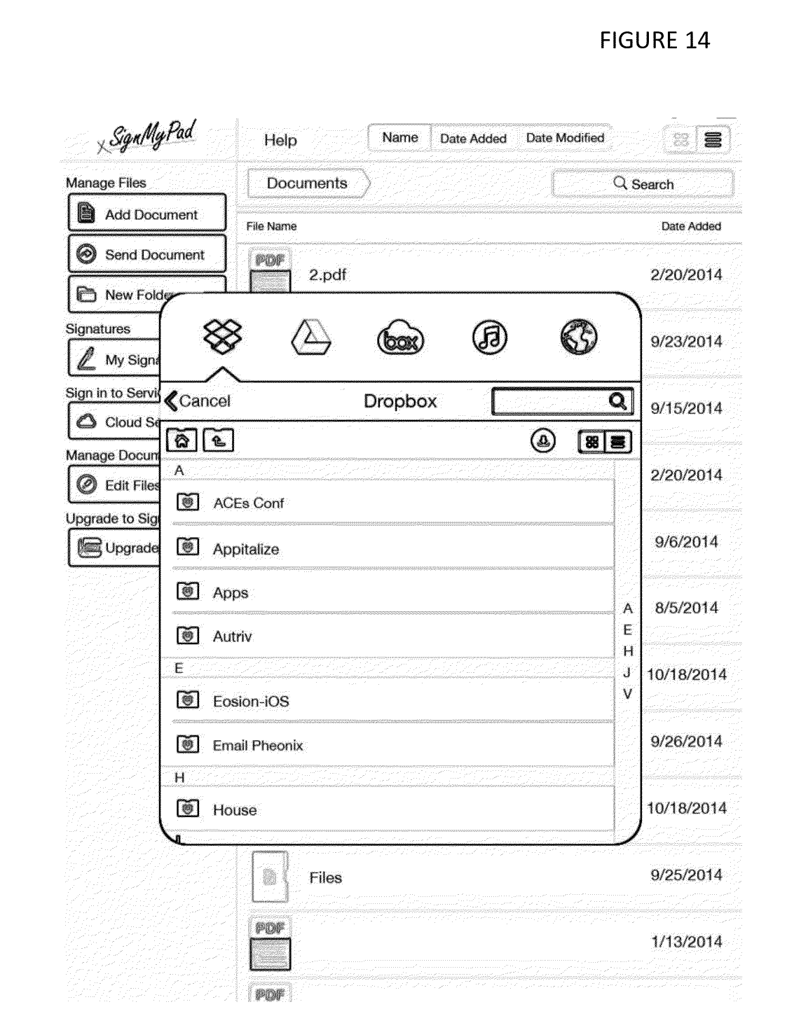

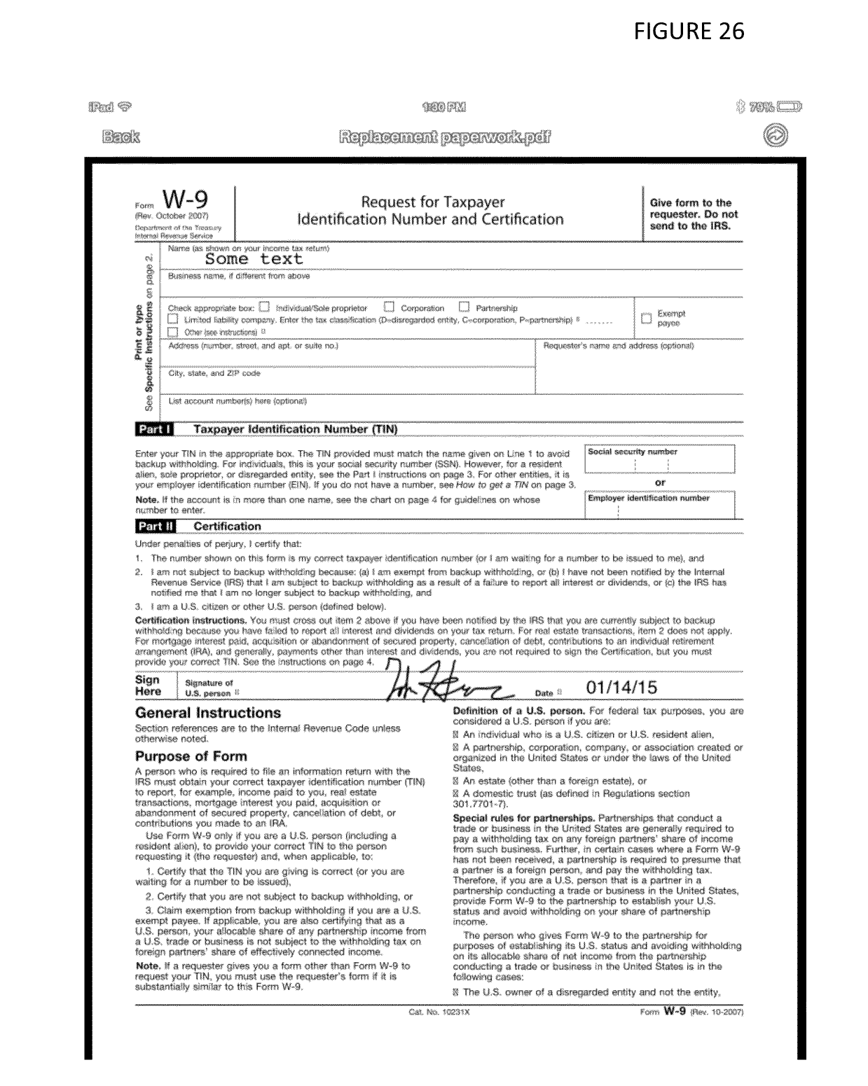

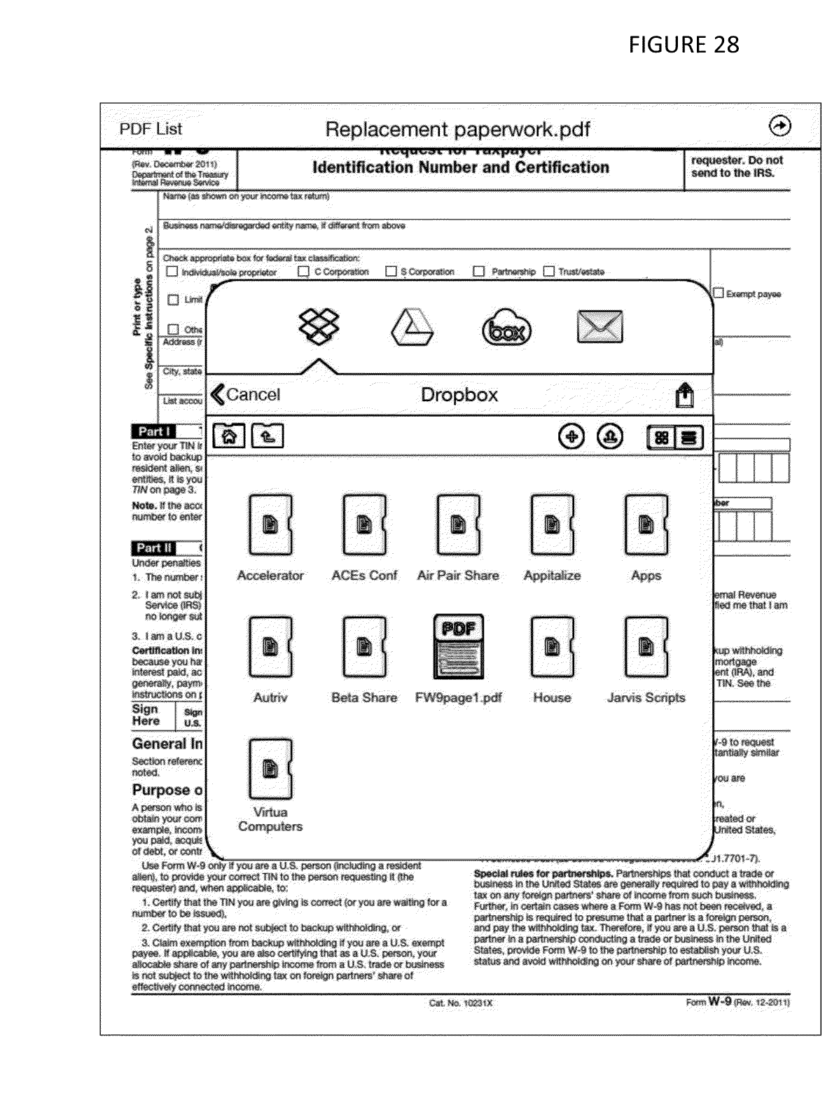

When a PDF is saved in the present application, the application may be used with a user's mobile device, tablet or computer internet to determine the location as well as the date and time as shown in FIGS. 8, 9 and 10. This data is stored to the metadata of the PDF. To access or view recorded or saved Meta-data information, a user may transfer the file to their computer or access a cloud based service. In another embodiment of the application, additional metadata can be saved, stored and recorded within the application and viewed by the user by selecting the PDF. In another embodiment of the present application, a user may record Meta-data relating to the user's profile. To view the metadata of the PDF on a computer a user may either select Get Info from the File menu in the Finder or choose Properties of the document, selecting the PDF option and view the keywords. After a user has saved their PDF, the application displays a preview of the saved PDF as shown in FIG. 11 and FIG. 26. A user can then either upload the PDF as described above or the user can send the PDF by selecting the Upload option. Similarly, a user may select the Email button and choose send. In the alternative, a user may choose to upload to Dropbox by selecting the upload button, selecting Dropbox, and choosing the upload button as shown in FIG. 14 and FIG. 28. If the user chooses to upload to Google Drive, a user may select the upload button, select Google Drive, and choose the upload button. To upload to Box, a user may select the upload button, choose Box, and select the upload button. To send the PDF to another application, a use may select upload, choose the Open In button and choose the appropriate application to open the PDF. To print the PDF, a user may select the upload button, choose to printer, and select print. This feature works with Airprint compatible printers. In another embodiment, the print feature may work with all types of printers.

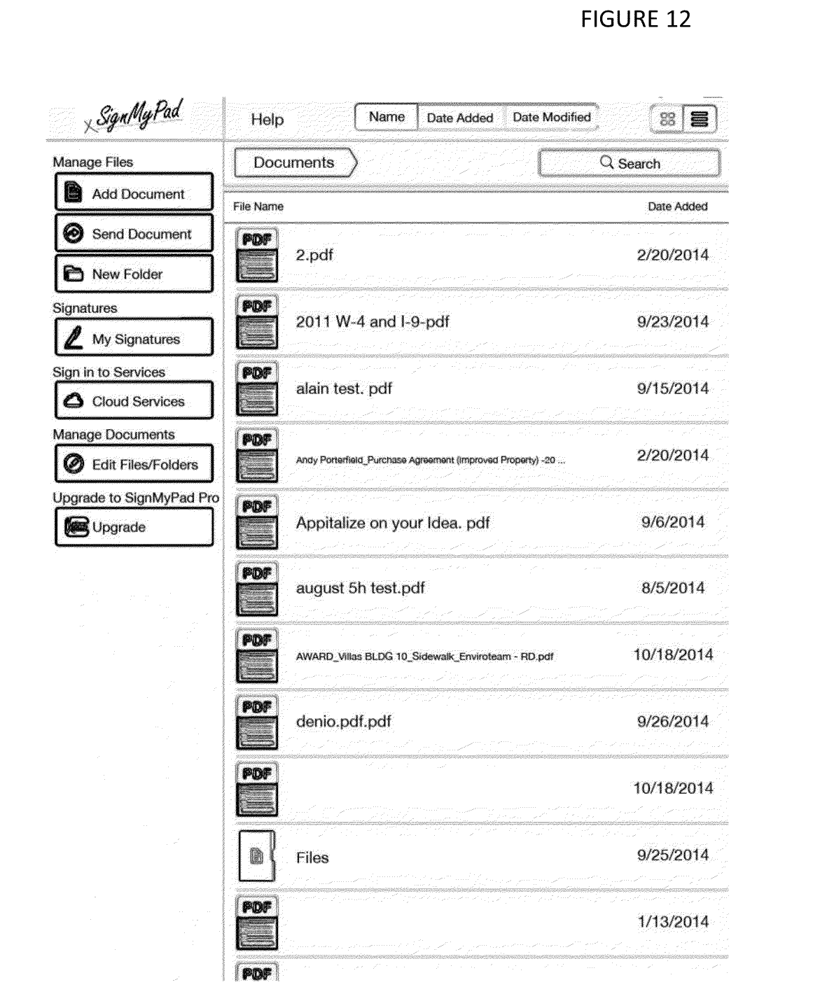

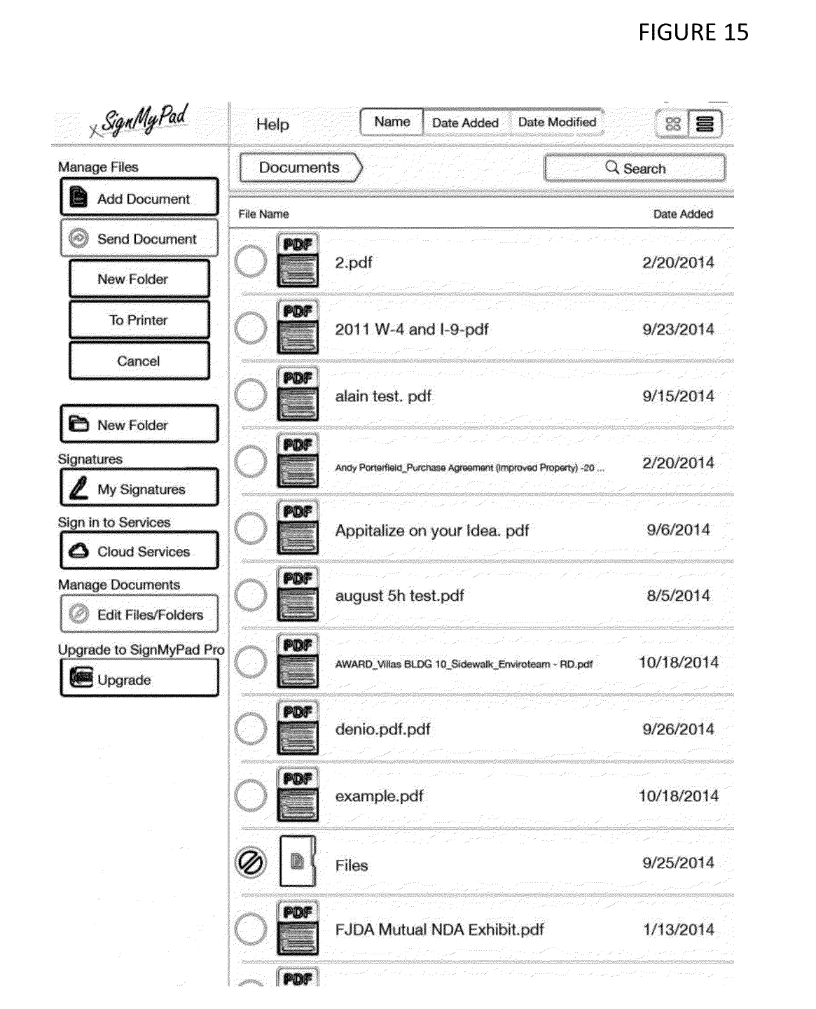

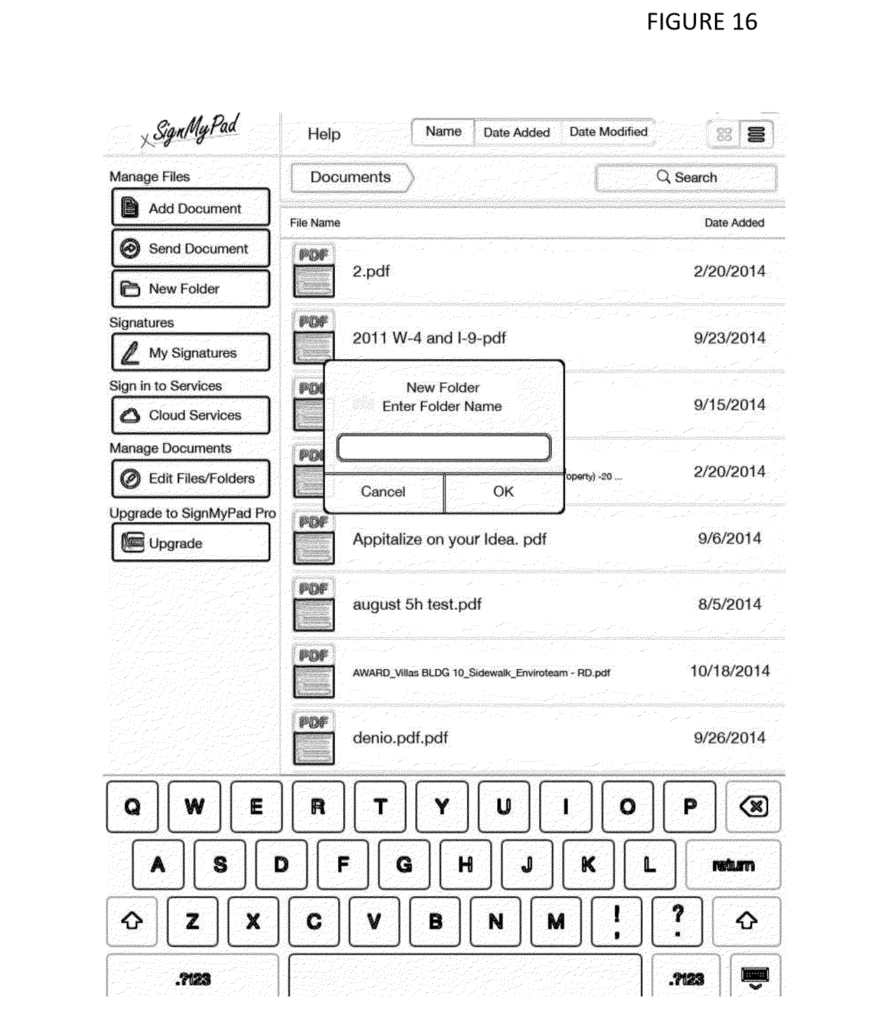

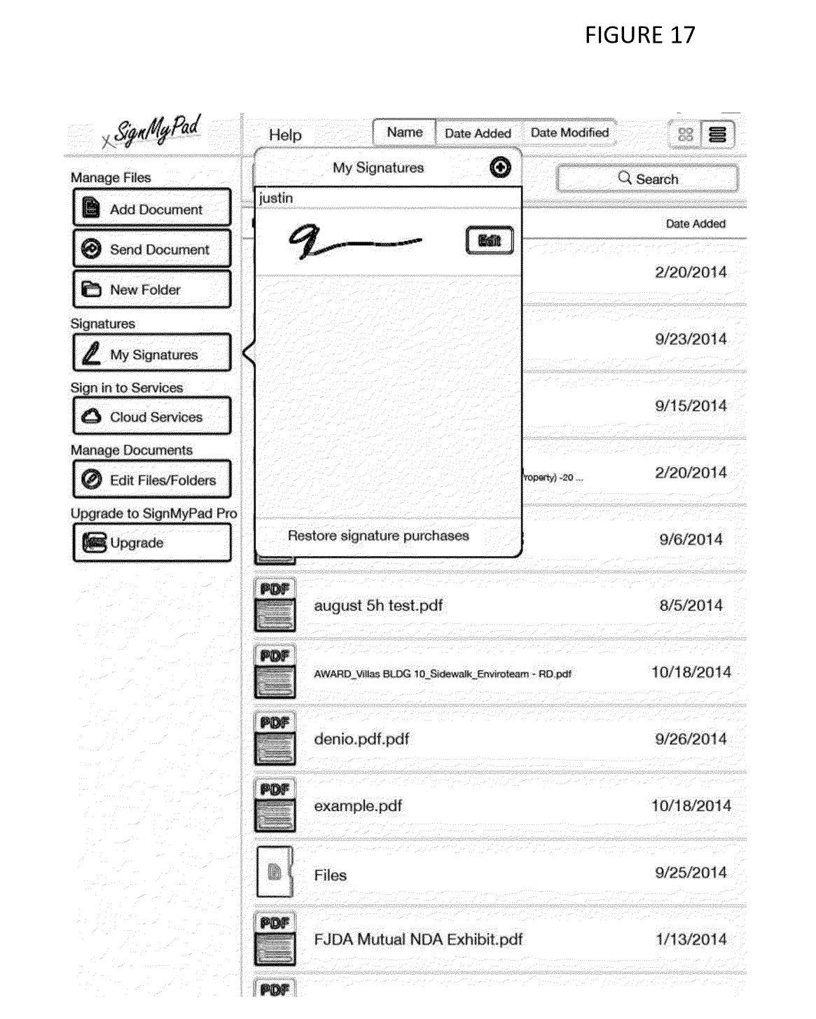

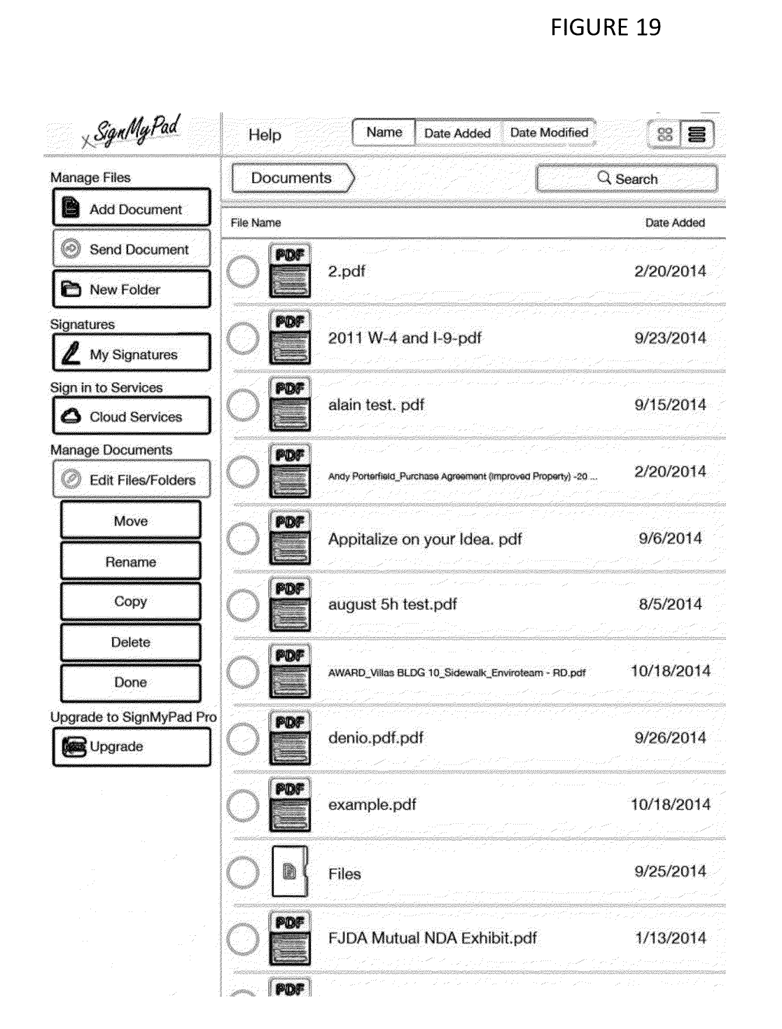

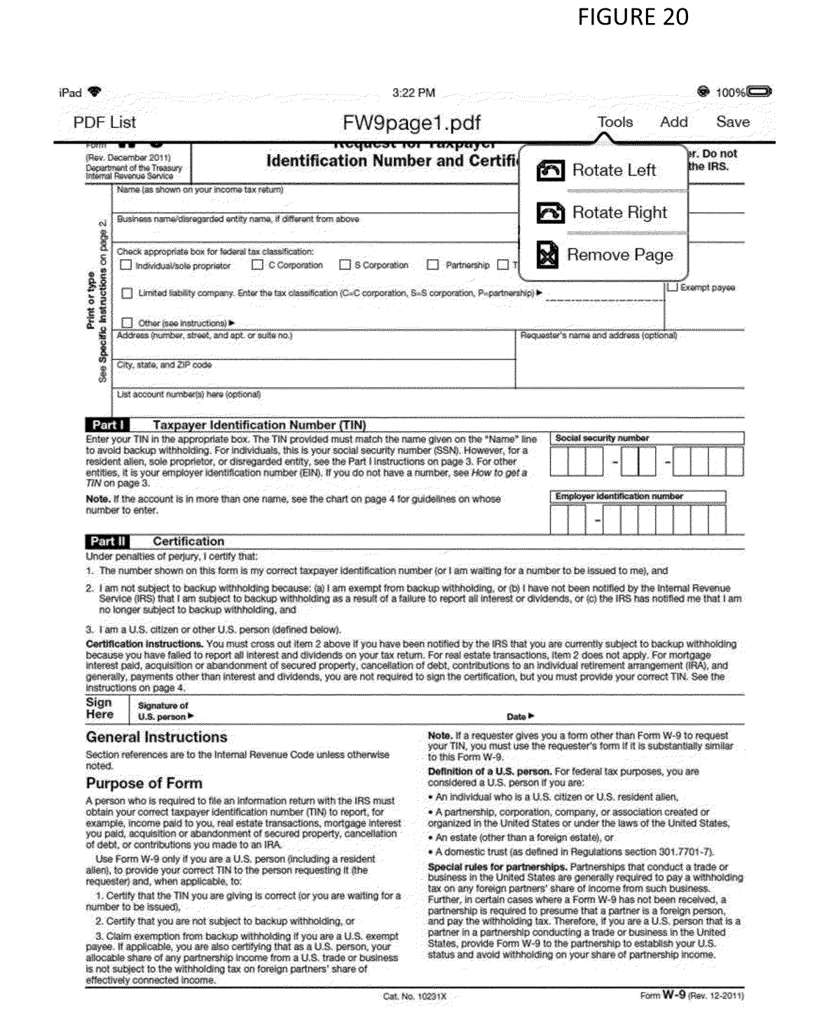

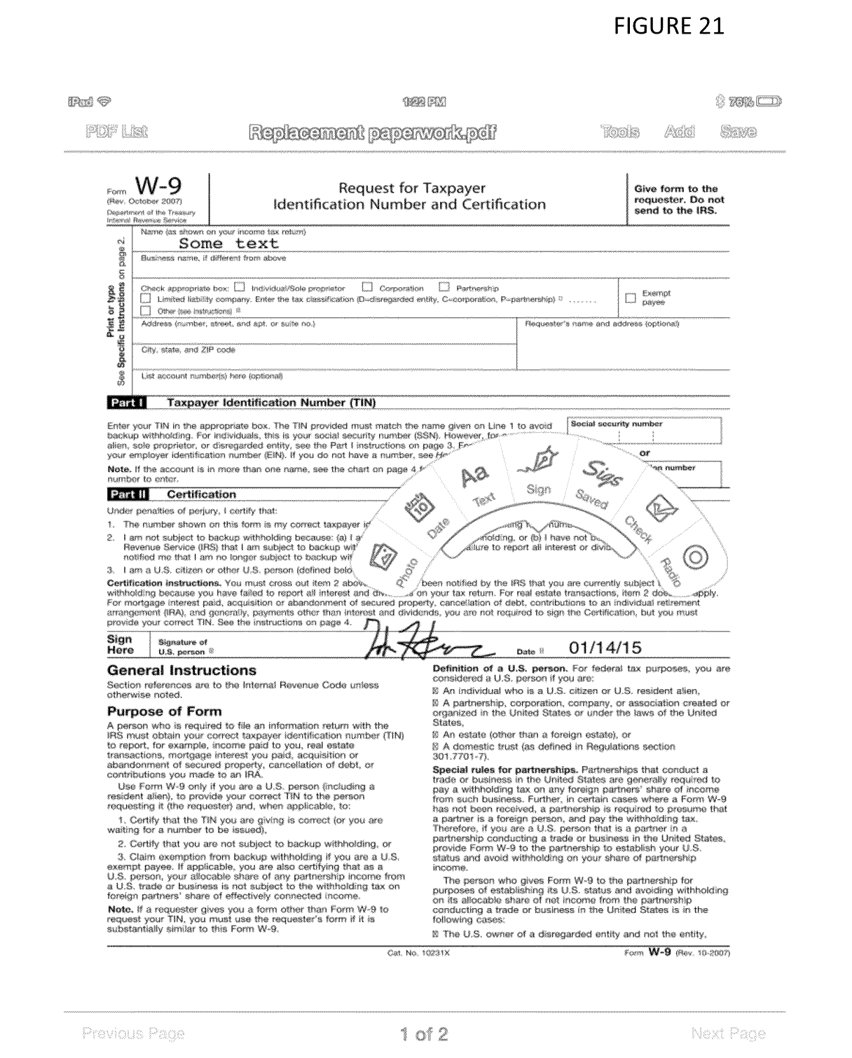

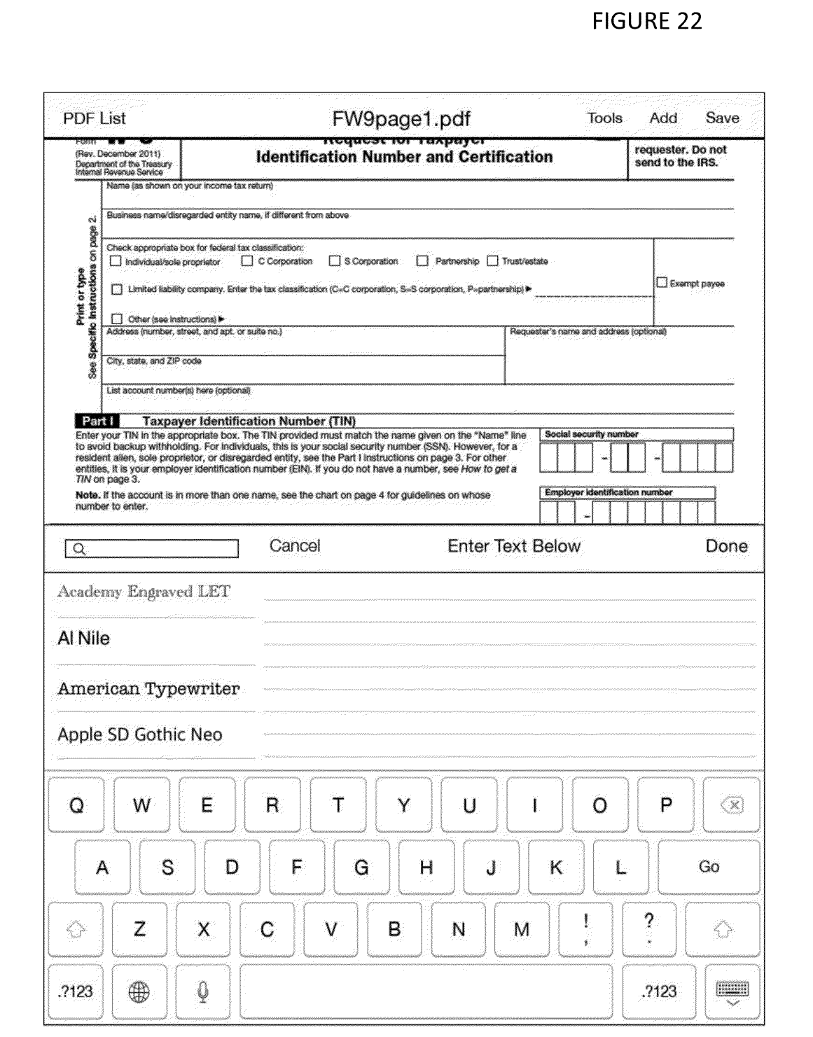

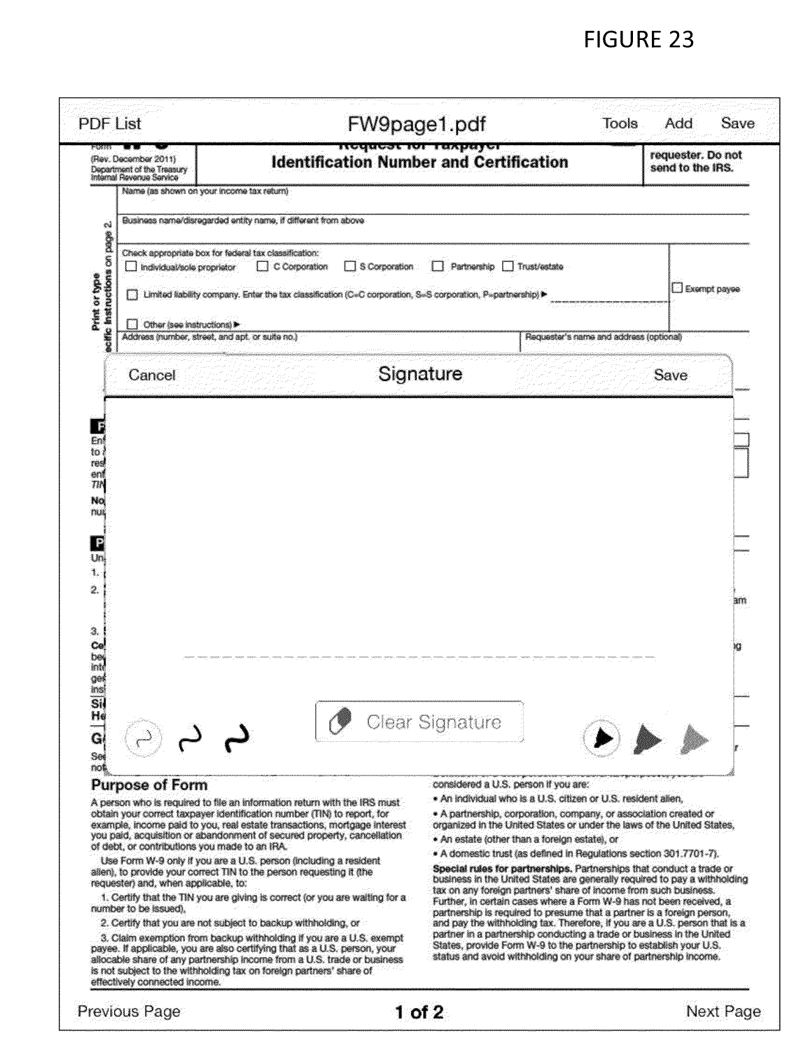

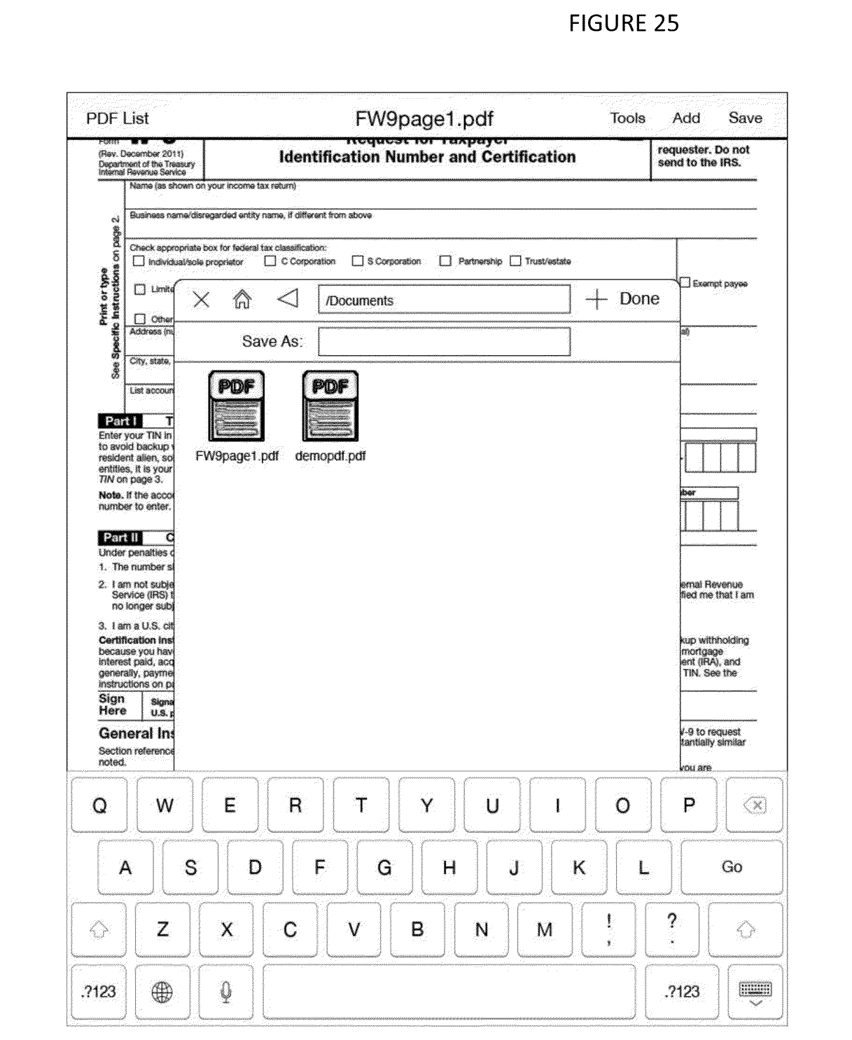

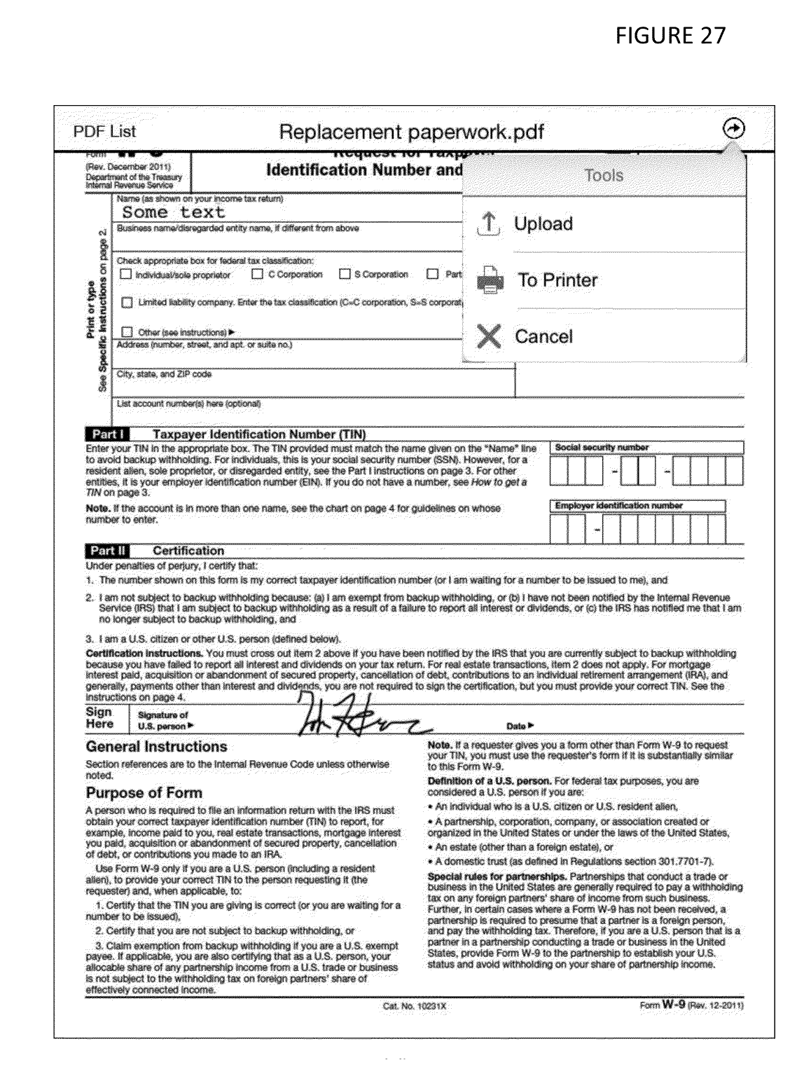

The Dashboard Tools include the following buttons/options:
Add Signature
Cloud Options—a user may Upload and Download from Dropbox, Google Drive, Box, and SignMyPad Cloud. A user may use iCloud and Dropbox Sync to sync the data between devices as shown in FIG. 18 and FIG. 27.
Saving Signature
Restoring Saved Signatures as show in My Signature view in FIG. 17
Switch between icon view as shown in FIG. 11 and list view as shown in FIG. 12 or FIG. 15
Move, Rename, Copy, Delete files and folders as shown in FIG. 16 and FIG. 19.
Detect Forms—If the PDF has forms, a user may select the Tools button when viewing a PDF and then choose Detect Forms
Rotate Current Page—a user may rotate the page a user is viewing by using the Rotate Left and Rotate Right buttons under the Tools menu as shown in FIG. 20. A user may rotate their document by 90 degree rotations. In another embodiment, a user may rotate their document counter clockwise and clockwise by incremental degrees.
Add Text—a user may select the Add button, choose Text, and add text and select done as shown in FIG. 22.
Add Signature—a user may select the Add button, choose Signature, choose pen color and thickness; draw a signature and select done as shown in FIG. 23
Add Saved Signature—a user may select the Add button, choose Saved Signature and then choose the proper saved signature
Add Checkmark (x)—a user may select the Add button, then choose the Checkmark as shown in FIG. 21
Add Radio Button (•)—a user may select the Add button, then choose the Radio Button as shown in FIG. 21
Add the Date—a user may select the Add button, choose Date, and select a format such as Short (04/28/80), Medium (Apr. 28, 1980), or Long (Apr. 28, 1980). In another embodiment, a user may select from other date formats.
Resizing an Element—a user may select the element once to bring up the size slider and then move the slider in either direction.
Deleting an Element—a user may select the element and select Delete.
Save your PDF—a user may select the Save menu, choose either Save (which will overwrite the original), Save As (which allows a user to choose a file name and file location for the new file, as shown in FIG. 25) or Save A Copy As (which allows a user to choose a location outside of the SignMyPad file structure).

The present application provides improvements over the art found in the digital signature references. The present application does not require a signature tags (small digital images that are used to accompany an HTML formatted message or document). Instead, the present application provides an improvement over such technology by allowing a user to digital sign many supported document formats. The present application is capable of storing and signing multiple PDF's with not just the aid of touch screen device but also with the insertion of multiple digitally stored signature. Accordingly, the present application is an improvement over technology that only allows a user to digitally sign a document using a touch screen device. The present application allows a user to sign a document in multiple places on a document. Accordingly, the present application is an improvement on systems and methods that identify the fields on an electronic document that require a signature as user of the present application need not identify fields of a document to insert a signature, but instead a may create multiple fields to add multiple signatures and multiple additional elements to an electronic document.

### Cloud Based System:

A user may select to add a document to be assigned from a variety of sources, including Dropbox, Google Drive, Box, Dropbox Sync, OneDrive, SkyDrive, SignMyPad Cloud and/or pull documents from the users cloud based system, such as iCloud or from the iCloud storage associated with the present invention. To access the systems cloud based storage service system, a user may select “cloud services.” The user may also store a plurality of signatures and access such signatures in the “my signatures” button.

Cloud Tools of the present application include:
Dropbox—To sign into Dropbox, select the Gear icon from the Dashboard, select on Dropbox and select login. Once logged in, the present application will be an approved application.
Google Drive—To sign into Google Drive, select the Gear icon from the Dashboard, select on Google Drive and select login. Once logged in, the present application will be able to download from Google Drive.
Box—To sign into Box, select the Gear icon from the Dashboard, select on Box and select login. Once logged in, the present application will be an approved application.
Dropbox Sync—To sign into Dropbox Sync, select the Gear icon from the Dashboard, select on Dropbox Sync and select login. Once logged in, the present application will create a folder on the user's Dashboard called SignMyPad Sync. This folder will sync between other versions of SignMyPad that have Dropbox Sync. This folder will not sync with iCloud.
iCloud—To enable iCloud syncing, select the Gear icon from the Dashboard, select on iCloud icon and choose Enable. Once enabled, the user's documents will sync with other iOS versions of the present application. iCloud will not sync the SignMyPad Sync folder created by Dropbox Sync.
SignMyPad Cloud—To sign into SignMyPad Cloud, select the Gear icon from the Dashboard, select on the SignMyPad Cloud icon, and select login. A user then may enter the credentials they have set on SignMyPad Cloud's web administration.

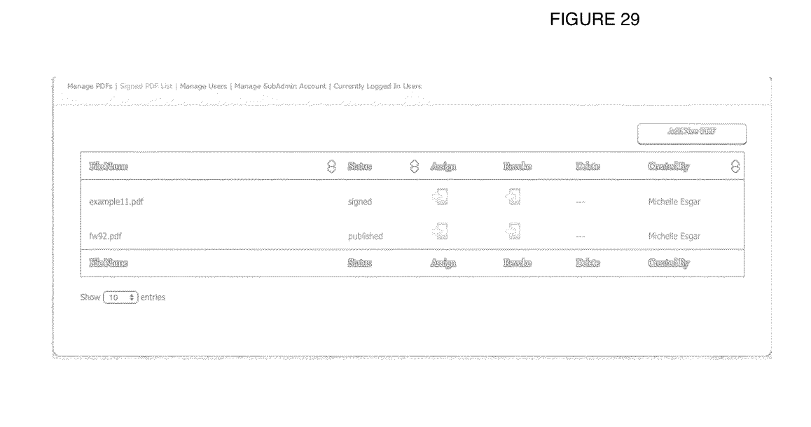

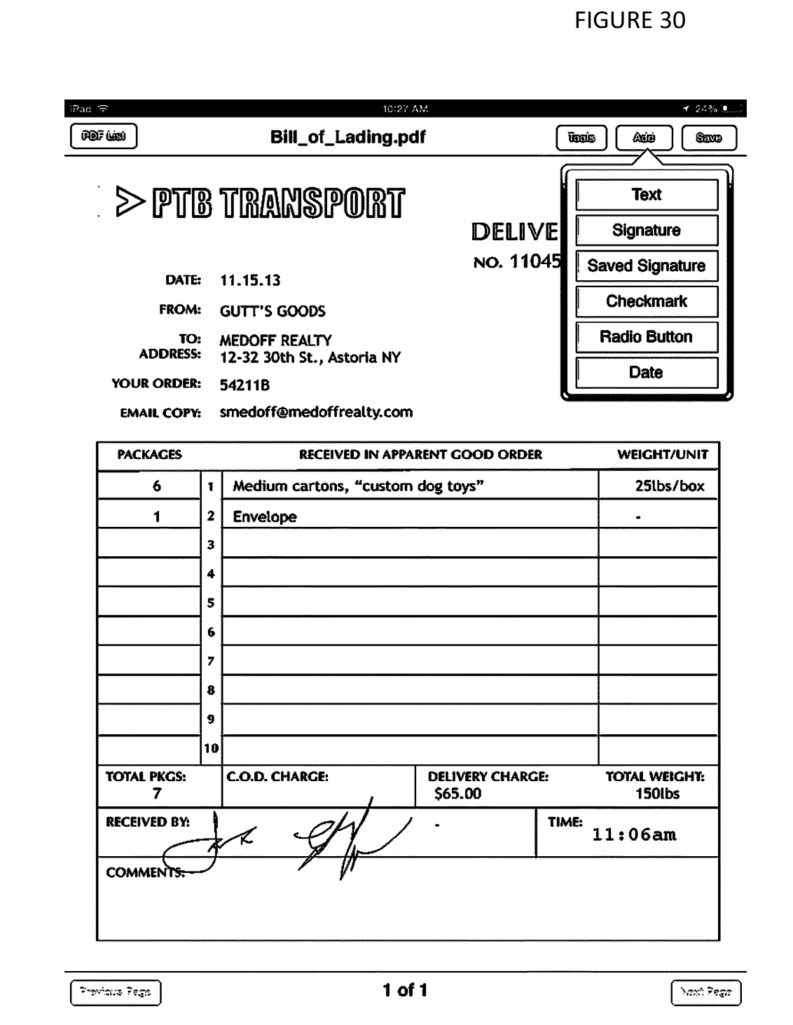

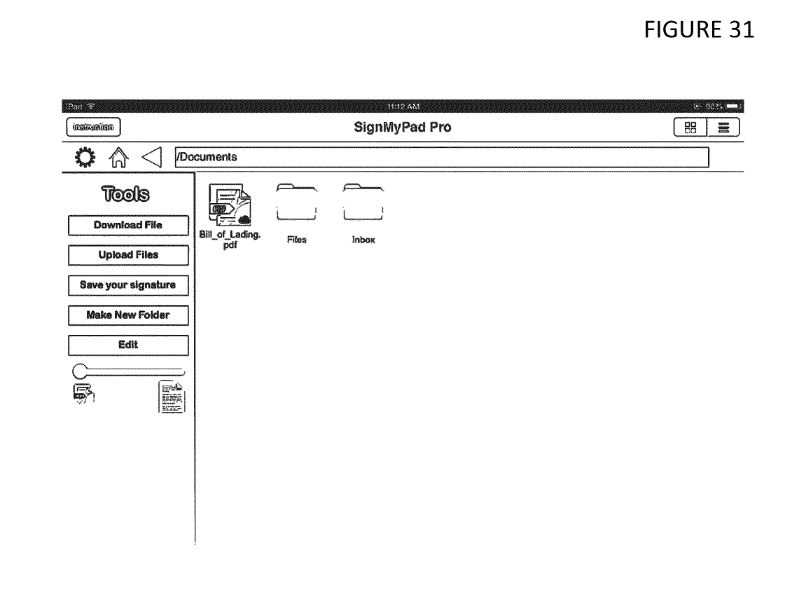

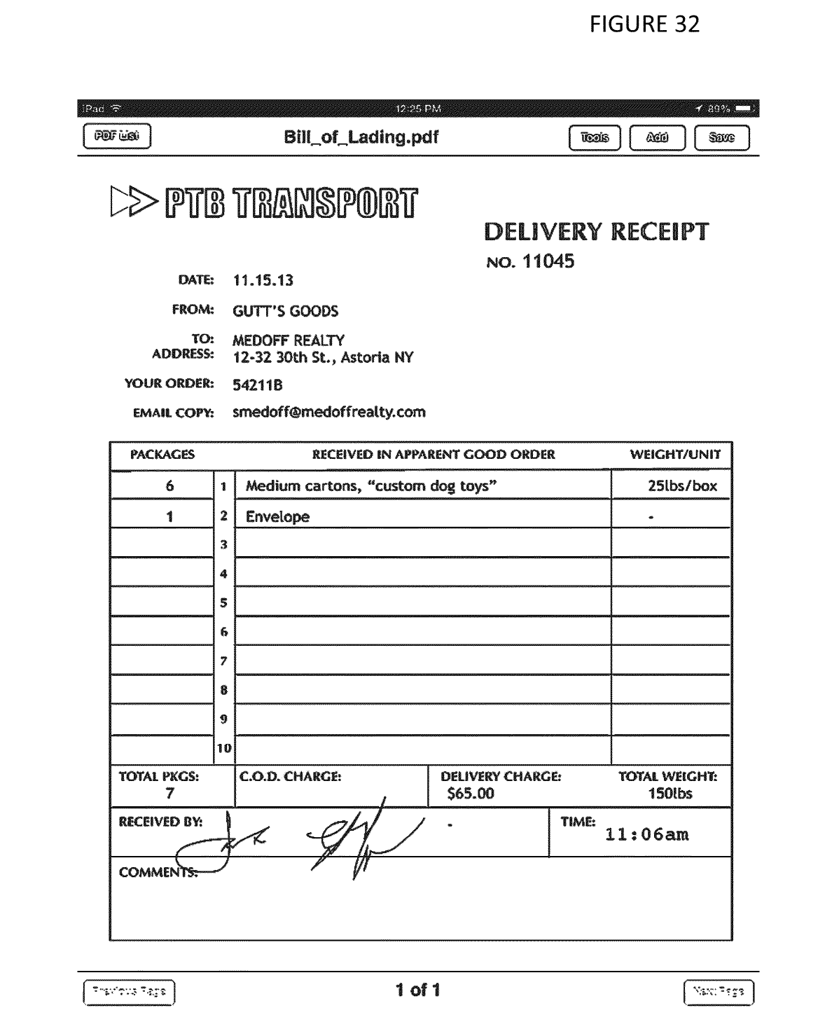

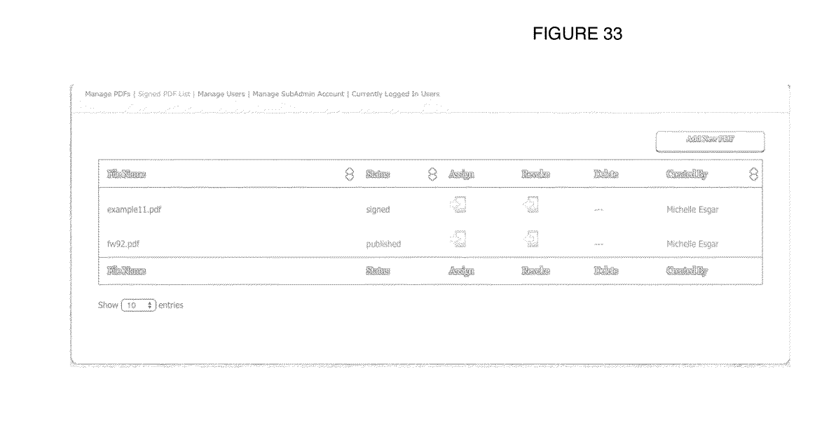

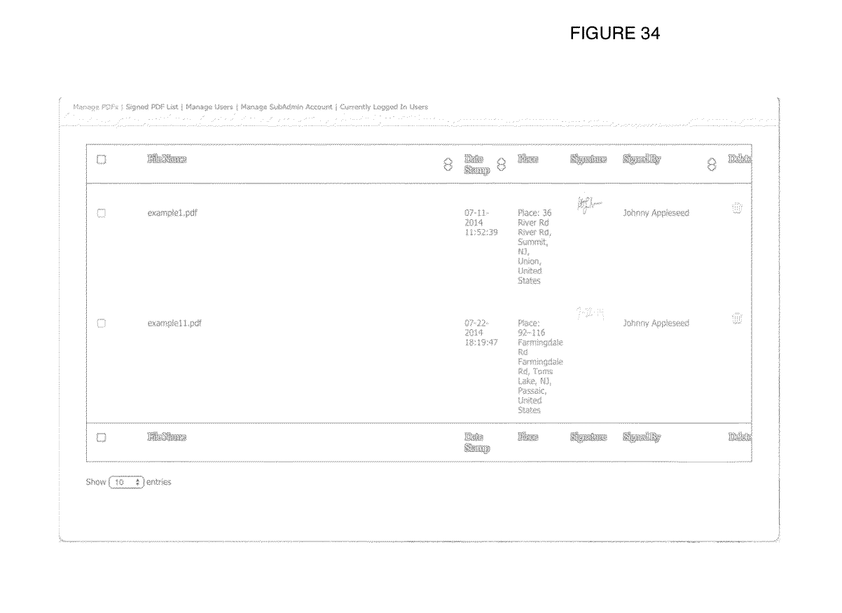

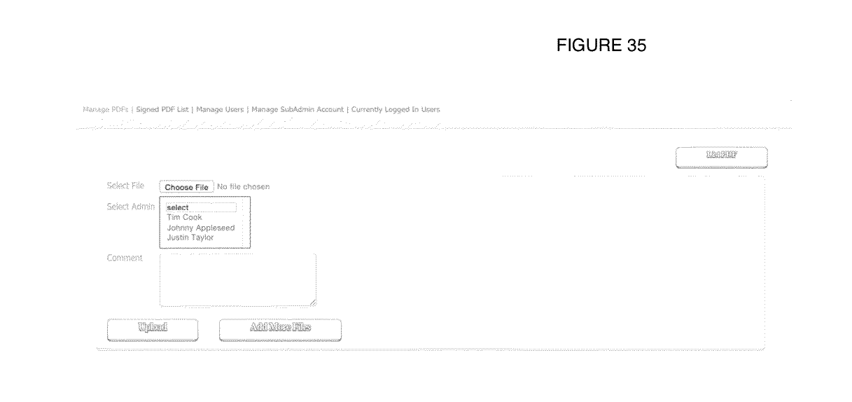

FIG. 29 shows the Main Screen of the cloud based system of the invention. The main screen includes the List of File in which an user can view the list of PDFs saved to their system. A user is able to view the PDF's that have been signed and returned. For example, as shown in FIG. 30, a sample Bill of Lading is shown that has been executed (signed) and published or pushed to the user's system or handheld mobile device of a user. In FIG. 30, the example Bill of Lading is shown with the add button feature which allows a user to add elements to their document. Such elements include text, signature, checkmark, and date or radio button. In another embodiment, additional elements can be discussed. In FIG. 31, the interoperability of the cloud based system is shown, where the example Bill of Lading has been published or pushed to the corresponding user's system such as the SignMyPad Pro application. In FIG. 32, the example Bill of Lading is shown with the digital executed signature added. In FIG. 33, the PDF is shown being saved and returned back to a corresponding web interface. The Bill of Lading is shown as having a status of “signed.” In FIG. 34, the Signed list feature is shown. Here the Bill of Lading is shown with details such as the date, time, location, and the first signature on the PDF (which usually corresponds to the same as the signature on the file, but in another embodiment this does not have to correspond). In another embodiment, other details can be added to the document. FIG. 35 shows where a PDF is uploaded to the website to be pushed to a corresponding system.

The cloud based system of the present application, SignMyPad Cloud is one under an Active Document Management structure. Active Document management system is a real time document manipulation software. The user of the Active Document Management system may push a PDF or document from within the cloud based system to another user of the cloud based system. Pushing a document to another user allows a user to download a PDF or Document from the cloud, hand held mobile device or corresponding computer or extract a PDF or Document from the cloud, hand held mobile device or corresponding computer, or assign a PDF or document from the cloud, hand held mobile device or corresponding computer to another user of the cloud based system. A user may assign the permission rights or access level to a PDF or document to another employee or user of the cloud based system. The PDF or document that has been assigned may be with or without the edits from the assignor of that PDF or document. Similarly, in an Active Document Management structure of the cloud based system of the present invention, a user may pull a PDF or document from another user of the cloud based system. Pulling a document occurs when a user wishes to revoke or rescind a PDF or document that has been saved or sent to another user of the cloud based system. Revocation or rescission may occur at any time, such as before or after edits, or before or after a document has been sent or saved. A PDF or document that has been pulled can be reversed. In another embodiment an assignee of a PDF or document may still be able to view or edit a pulled PDF or document.

In another embodiment of the application and the cloud based system of the present invention, the system may read document files of any type such as .doc, .xls, .txt, .rtf wherein the document can still be edited and saved as a PDF. In another embodiment, the system will allow for signatures, editing, and adding of elements in any font and in any color. In another embodiment of the invention the system can be integrated with other sales, service, marketing, community, analytics, and application programs such as SalesForce. In another embodiment, the system may be fully integrated with credit card processing programs and other financial software.

In another embodiment of the application and the cloud based system of the present invention, the system may be integrated with various email programs to allow for users to reply to emails and attach saved PDFs. In another embodiment, the interoperability between the application and cloud based system will include push notifications for users. In another embodiment, the application and cloud based system may be utilized by delivery companies and their proprietary softwares. In another embodiment, user document files may be synced between different versions of operating systems such as iOS, Android, or Windows. In another embodiment, the application and system may be a computer based application.

In another embodiment of the application of the invention, the electronic signature may be encrypted and accessed and viewed via password. Such encryption may be associated with a specified PDF or a specified signature in order to allow for multiple encrypted files and signatures. In another embodiment of the application, a user's hand held device or any device with a camera or image capturing software, may capture an image of a signature, whether the signature is wet or electronic and allow a user to encrypt and insert the signature into a PDF or document. In another embodiment of the application of the invention, encryption of a PDF or document may be achieved via biometrics. In this embodiment, a user may electronically sign their PDF or document via biometrics such as placing their fingerprint directly on the signature line of the electronic document on the hand held or mobile device or by the mobile or hand held device capturing a retina scan of the user. In another embodiment, the PDF list of documents may be accessed only via the biometrics of the user. In another embodiment of the application, a user's biometrics may be used to open and access the application or system or be used to confirm the validity or identity of the user.

In another embodiment of the application and the cloud based system of the present invention, a centralized signature database may be created wherein the plurality of user's and their corresponding electronic signatures may be captured, stored and used from a centralized signature depository. In this embodiment of the invention, the centralized signature depository may be used be registered and recognized users of the application or cloud based service of the application.

In another embodiment of the application of the invention, a magnetic stylus can be used in conjunction with the hand held or mobile devices in which the present system is used. The stylus has a magnetic core and can be of various lengths. The stylus can be snapped into or attached to the hand held or mobile devices in which the present system is used with.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A cloud based computer implemented system for managing a plurality of portable digital format documents, comprising;
memory that stores computer-executable instructions; and
a processor, communicatively coupled to the memory that facilitates execution of the computer-executable instructions to at least:
transmit, via the processor, a portable digital format document, from a sender, to be digitally signed by a user;
open, via the processor, a portable digital format document stored in the system of the user and the sender;
wherein the user digitally signs the portable digital format document and the portable digital format document is stored in a cloud based environment of the user and the sender;
manage, via the processor, the storage of the signed portable digital format document;
determine, via the processor, whether the portable digital format document has been digitally signed and alerting the user and the sender if it has not; and
record, via the processor, the metadata associated with the portable digital format document.

2. The system of claim 1, wherein a plurality of elements is added to the portable digital format document.

3. The system of claim 1, wherein the metadata comprise at least one of date, time and location of the portable digital format document when digitally signed.

4. The system of claim 1, wherein the portable digital format document is digitally signed by a plurality of users.

5. The system of claim 1, wherein a digital signature is located in multiple locations on the portable digital format document.

6. The system of claim 1, wherein a plurality of portable digital format documents can be managed.

7. The system of claim 1, wherein the portable digital format document to be accessed is uploaded or downloaded from at least one of a cloud based system, a mobile or hand held device, and a third party document management program of the user and the sender.

8. The system of claim 1, wherein the plurality of elements include at least one of text, signature, saved signature, checkmark, radio button, and date.

9. The system of claim 1, wherein a digital image or photo is added to the portable digital format document.

10. The system of claim 10, wherein metadata of the digital image or digital photo is stored on the cloud based system of the user and the sender.

11. The system of claim 1, wherein the portable digital format document can be resized or rotated.

12. The system of claim 1, wherein a plurality of signatures are stored for future insertion into the portable digital format document.

13. The system of claim 1, wherein the time and date of the portable digital format document is recorded for authentication purposes.

14. A cloud based computer implemented method for managing a plurality of portable digital format documents, the steps of which comprise:
transmitting, via a processor, a portable digital format document, from a sender, to be digitally signed by a user;
opening via the processor, the portable digital format document stored in a system of the user or the sender;
digitally signing the portable digital format document;
storing, via the processor, the portable digital format document in a cloud based environment of the user or the sender;
managing, via the processor, the storage of the signed portable digital format document;
determining, via the processor, whether the portable digital format document has been digital signed and alerting the user and the sender if it has not; and
recording, via the processor, the metadata associated with the portable digital format document.

15. The method of claim 14, wherein a plurality of elements is added to the portable digital format document.

16. The method of claim 14, wherein the metadata comprise at least one of date, time and location of the portable digital format document when digitally signed.

17. The method of claim 14, wherein the system of the user includes at least one of Google Drive, Box, Dropbox, Dropbox sync, and SignMyPad Cloud.

18. The method of claim 14, wherein the portable digital format document is uploaded or downloaded from an email or from an application of the user or the sender.
